(19) United States
(12) Patent Application Publication
(10) Pub. No.: US 2023/0299400 A1
(43) Pub. Date: Sep. 21, 2023

(54) Bipolar Battery

(71) Applicants: Furukawa Electric Co., Ltd., Tokyo (JP); The Furukawa Battery Co., Ltd., Yokohama (JP)

(72) Inventors: Akira Tanaka, Tokyo (JP); Yasuo Nakajima, Tokyo (JP); Kenichi Suyama, Tokyo (JP); Hiroki Tanaka, Tokyo (JP); Yoshinobu Taira, Iwaki (JP); Kenji Hirota, Iwaki (JP)

(21) Appl. No.: 18/325,304

(22) Filed: May 30, 2023

Related U.S. Application Data
(63) Continuation of application No. PCT/JP2021/042075, filed on Nov. 16, 2021.

(30) Foreign Application Priority Data
Nov. 27, 2020 (JP) 2020-197473
Feb. 12, 2021 (JP) 2021-020455

(51) Int. Cl. H01M 50/186; H01M 10/18; H01M 4/14; H01M 50/51; H01M 50/103

(52) U.S. Cl. CPC H01M 50/186; H01M 10/18; H01M 4/14; H01M 50/51; H01M 50/103

(57) ABSTRACT

A bipolar battery includes a plurality of cell members and a plurality of frame units configured to form a plurality of cells individually housing the plurality of cell members. Each of the plurality of frame units has joining surfaces facing each other in the stacking direction of the cell members, which are joined to each other by a joining material. On outer side surfaces of the frame units adjacent to each other in the stacking direction, a groove is formed which communicates between the joining surfaces to be joined and opens to the outer side surfaces. A water sealing material is disposed in the groove. This arrangement provides a bipolar battery capable of reliably preventing an electrolyte from leaking out of a cell by a simple seal configuration.

### CROSS-REFERENCE TO RELATED APPLICATION(S)

This application is a continuation of PCT Application No. PCT/JP2021/042075, filed Nov. 16, 2021, the disclosure of which is incorporated herein in its entirety by reference.

### TECHNICAL FIELD

The present invention relates to a bipolar battery.

### BACKGROUND

In recent years, power generation facilities using natural energy such as sunlight and wind power have been increasing. Because such power generation facilities cannot control the amount of power generation, the power generation facilities level a power load by using a storage battery. In other words, when the power generation amount is larger than the consumption amount, the difference is charged to the storage battery, and when the power generation amount is smaller than the consumption amount, the difference is discharged from the storage battery. As the above-described storage battery, a lead storage battery is frequently used from the viewpoint of economic efficiency, safety, and the like, and in particular, a bipolar lead storage battery has attracted attention from the viewpoint of energy density.

The bipolar lead storage battery includes a plurality of cell members in each of which an electrolyte layer is interposed between a positive electrode having a positive active material layer and a negative electrode having a negative active material layer. The bipolar lead storage battery also includes a plurality of frame units made of resin for housing the cell members and is configured by connecting the cell members to each other in series by alternately stacking and assembling the cell members and the frame units.

In the bipolar lead storage battery, an electrolyte layer constituting a cell member in a cell is impregnated with an electrolyte. Therefore, it is necessary to prevent the electrolyte from leaking out of the cell.

A sealed bipolar battery assembly illustrated in JP Patent Publication No. 6571091 B2, for example, is conventionally known as a battery assembly having a seal structure for preventing an electrolyte from leaking out.

The sealed bipolar battery assembly illustrated in JP Patent Publication No. 6571091 B2 includes a casing frame in which a first current collector and a second current collector are disposed therein, and two end caps attached to an upper portion and a lower portion of the casing frame so as to be fitted to each other, whereby an electrolyte region is defined by the first current collector, the second current collector, the casing frame, and the end caps.

To prevent the electrolyte from leaking out, a plurality of plastic seals and adhesive seals are provided between the casing frame and the end caps around each of the first current collector and the second current collector. The casing frame and the end caps are joined by a welded joining portion using hot plate welding or other welding technologies.

### SUMMARY

However, the conventional sealed bipolar battery assembly illustrated in JP Patent Publication No. 6571091 B2 has the following problems.

Specifically, in the case of the sealed bipolar battery assembly illustrated in JP Patent Publication No. 6571091 B2, the seal configuration for sealing leakage of the electrolyte to the outside from between the casing frame and the end caps requires that a plurality of plastic seals and adhesive seals are provided between the casing frame and the end caps around each of the first current collector and the second current collector and requires that the casing frame and the end caps are joined by a welded joining portion using hot plate welding or other welding technologies, whereby there is a problem that the seal configuration is complicated.

In view of the above, an object of the present invention is to provide a bipolar battery capable of reliably preventing an electrolyte from leaking out of a cell by a simple seal configuration.

To solve the above-described problems, the present invention provides a bipolar battery having the following configuration.
(1) The bipolar battery includes a plurality of cell members each including a positive electrode having a positive active material layer, a negative electrode having a negative active material layer, and an electrolyte layer interposed between the positive electrode and the negative electrode. The bipolar battery also includes a plurality of frame units forming a plurality of cells individually housing the plurality of cell members, whereby the cell members adjacent to each other in a stacking direction are electrically connected to each other in series.
(2) Each of the plurality of frame units has joining surfaces facing each other in the stacking direction of the cell members, which are joined to each other by a joining material.
(3) A groove is formed on outer side surfaces of the frame units adjacent to each other in the stacking direction, the groove communicating between the joining surfaces to be joined and opening to the outer side surfaces, and a water sealing material is disposed in the groove.

For a bipolar battery according to embodiments of the present invention, each of the plurality of frame units has the joining surfaces facing each other in the stacking direction of the cell members, which are joined by the joining material, and on the outer side surfaces of the frame units adjacent to each other in the stacking direction, the groove is formed that communicates between the joining surfaces to be joined and opens to the outer side surfaces, and the water sealing material is disposed in the groove.

Thus, even if the electrolyte leaking out of the cell escapes the joining material and leaks out from between the joining surfaces, the electrolyte can be reliably prevented from leaking out from the frame units by the water sealing material.

The seal configuration may be formed simply by joining the joining surfaces of the frame units adjacent to each other in the stacking direction by the joining material and disposing the water sealing material in the groove that is formed on the outer side surfaces of the frame units. The groove communicates between the joining surfaces to be joined and opens to the outer side surfaces, whereby the seal configuration can be simplified.

Therefore, it is possible to provide a bipolar battery capable of reliably preventing the electrolyte from leaking out of the cell by a simple seal configuration.

For a bipolar battery according to embodiments of the present invention, each of the plurality of frame units includes a rim having the joining surfaces facing each other in the stacking direction of the cell members. The joining surfaces of rims of the frame units adjacent to each other in the stacking direction are joined by the joining material. The groove is formed on outer side surfaces of rims of the frame units adjacent to each other in the stacking direction, and the water sealing material is disposed in the groove.

Thus, even if the electrolyte leaking out of the cell escapes the joining material and leaks out from between the joining surfaces of the rims, the electrolyte can be reliably prevented from leaking out from the frame units by the water sealing material. The seal configuration may be formed simply by joining the joining surfaces of the rims adjacent to each other in the stacking direction by the joining material and disposing the water sealing material in the groove which is formed on the outer side surfaces of the rims. The groove communicates between the joining surfaces to be joined and opens to the outer side surfaces, whereby the seal configuration can be simplified.

For a bipolar battery according to embodiments of the present invention, because an open end of the groove is provided with a protrusion protruding from the open end, the water sealing material disposed in the groove can be retained and positioned, and the water sealing material can be suppressed from leaking out when the liquid water sealing material is poured into the groove before being solidified. The protrusion can improve preventing the electrolyte from leaking out.

For a bipolar battery according to embodiments of the present invention, the plurality of frame units includes one or a plurality of bipolar plates disposed between the cell members adjacent to each other in the stacking direction, a first end plate disposed at one end in the stacking direction of the plurality of cell members, and a second end plate disposed at an other end in the stacking direction. The plurality of frame units also includes a plurality of spacers disposed between the bipolar plates adjacent to each other in the stacking direction, between the first end plate and the bipolar plate, and between the second end plate and the bipolar plate, whereby a plurality of cells individually housing the plurality of cell members is formed by the one or plurality of bipolar plates, the first end plate and the second end plate, and the plurality of spacers. The joining surface formed on the other surface in the stacking direction of the first end plate and the joining surface formed on the one surface in the stacking direction of the spacer, which are adjacent to each other in the stacking direction, are joined to each other by the joining material. The joining surface formed on the one surface in the stacking direction of the bipolar plate and the joining surface formed on the other surface in the stacking direction of the spacer, which are adjacent to each other in the stacking direction, are joined to each other by the joining material. The joining surface formed on the other surface in the stacking direction of the bipolar plate and the joining surface formed on the one surface in the stacking direction of the spacer, which are adjacent to each other in the stacking direction, are joined to each other by the joining material. The joining surface formed on the one surface in the stacking direction of the second end plate and the joining surface formed on the other surface in the stacking direction of the spacer, which are adjacent to each other in the stacking direction, are joined to each other by the joining material. The grooves are formed on the outer side surface of the first end plate and the outer side surface of the spacer, which are adjacent to each other in the stacking direction, the outer side surface of the spacer and the outer side surface of the bipolar plate, which are adjacent to each other in the stacking direction, and the outer side surface of the second end plate and the outer side surface of the spacer, which are adjacent to each other in the stacking direction. The water sealing material is disposed in the grooves.

Thus, even if the electrolyte leaking out of the cell escapes the joining material and leaks out from between the joining surfaces, the electrolyte can be reliably prevented from leaking out from the bipolar plate, the first end plate, the second end plate, and the spacer by the water sealing material.

The seal configuration may be formed by simply joining the above-described joining surfaces by the joining material, forming a groove which communicates between the joining surfaces to be joined and opens to the outer side surfaces of the bipolar plate or the like, and disposing the water sealing material in the groove, whereby the seal configuration can be simplified.

For a bipolar battery according to embodiments of the present invention, the groove communicating between the joining surface formed on one surface in the stacking direction of the bipolar plate and the joining surface formed on the other surface in the stacking direction of the spacer and the groove communicating between the joining surface formed on the other surface in the stacking direction of the bipolar plate and the joining surface formed on one surface in the stacking direction of the spacer are an identical common groove communicating with each other. The water sealing material disposed in the common groove is a common water sealing material.

Thus, a groove on one surface side in the stacking direction of the bipolar plate and a groove on the other surface side in the stacking direction may be formed by one common groove, so that groove machining can be easily performed, and one common water sealing material may be disposed in the common groove. In this way, there is an advantage in that the number of components can be reduced.

For a bipolar battery according to embodiments of the present invention, because an open end of the groove is provided with a protrusion protruding from the open end, the water sealing material disposed in the groove can be retained and positioned, and the water sealing material can be suppressed from leaking out when the liquid water sealing material is poured into the groove before being solidified. The protrusion can increase the creepage distance in the groove and improve the effect of preventing the electrolyte from leaking out.

For a bipolar battery according to the present invention, because an open end of the common groove is provided with a protrusion protruding from the open end, the common water sealing material disposed in the common groove can be retained and positioned, and the common water sealing material can be suppressed from leaking out when the liquid common water sealing material is poured into the groove before being solidified. The protrusion can increase the creepage distance in the common groove and improve the effect of preventing the electrolyte from leaking out.

For a bipolar battery according to embodiments of the present invention, because the water sealing material is dope cement, when the water sealing material is disposed in the groove, liquid dope cement obtained by dissolving a thermoplastic resin material in a solvent may be poured into the groove and dried to volatilize the solvent. The water sealing material made of the dope cement can be disposed in the groove by a simple technique.

For a bipolar battery according to embodiments of the present invention, because the water sealing material is hot melt, when the water sealing material is disposed in the groove, hot melt, which is an adhesive liquefied by applying heat to a resin material, may be poured into the groove and then cooled to be solidified. The water sealing material made of the hot melt can be disposed in the groove by a simple technique.

For a bipolar battery according to embodiments of the present invention, because the water sealing material is a liquid gasket, when the water sealing material is disposed in the groove, a liquid gasket, which is an adhesive that maintains a liquid state at normal temperature and forms an elastic film or an adhesive thin film when dried after application, may be poured into the groove and then dried to be solidified. The water sealing material made of the liquid gasket can be disposed in the groove by a simple technique.

For a bipolar battery according to embodiments of the present invention, because the common water sealing material is dope cement, when the common water sealing material is disposed in the common groove, liquid dope cement obtained by dissolving a thermoplastic resin material in a solvent may be poured into the common groove and dried to volatilize the solvent. The common water sealing material made of the dope cement can be disposed in the common groove by a simple technique.

For a bipolar battery according to embodiments of the present invention, because the common water sealing material is hot melt, when the common water sealing material is disposed in the common groove, hot melt, which is an adhesive liquefied by applying heat to a resin material, may be poured into the common groove and then cooled to be solidified. The common water sealing material made of the hot melt can be disposed in the common groove by a simple technique.

For bipolar battery according to embodiments of the present invention, because the common water sealing material is a liquid gasket, when the common water sealing material is disposed in the common groove, a liquid gasket, which is an adhesive that maintains a liquid state at normal temperature and forms an elastic film or an adhesive thin film when dried after application, may be poured into the common groove and then dried to be solidified. The common water sealing material made of the liquid gasket can be disposed in the common groove by a simple technique.

Because the bipolar battery according to embodiments of the present invention is a bipolar lead storage battery in which the positive electrode has a positive electrode lead layer and the negative electrode has a negative electrode lead layer, the bipolar lead storage battery can reliably prevent the electrolyte from leaking out of the cell by a simple seal configuration.

### BRIEF DESCRIPTION OF THE DRAWINGS

FIG. 1 is a cross-sectional view illustrating a schematic configuration of a bipolar battery according to a first embodiment of the present invention.

FIG. 2 is an enlarged view of a portion indicated by an arrow X in FIG. 1.

FIG. 3 is a cross-sectional view of a water sealing material used in the bipolar battery illustrated in FIG. 1.

FIG. 4 is a cross-sectional view illustrating a schematic configuration of a bipolar battery according to a second embodiment of the present invention.

FIG. 5 is an enlarged view of a portion indicated by an arrow Y in FIG. 4.

FIG. 6 is a cross-sectional view of a water sealing material used in the bipolar battery illustrated in FIG. 4.

FIG. 7 is a cross-sectional view illustrating a schematic configuration of a bipolar battery according to a third embodiment of the present invention.

FIG. 8 is an enlarged view of a portion indicated by an arrow Z in FIG. 7.

FIG. 9 is a cross-sectional view of a water sealing material used in the bipolar battery illustrated in FIG. 7.

FIG. 10 is a cross-sectional view illustrating a schematic configuration of a bipolar battery according to a fourth embodiment of the present invention.

FIG. 11 is an enlarged view of a portion indicated by an arrow X in FIG. 10.

FIG. 12 is a cross-sectional view of a water sealing material used in the bipolar battery illustrated in FIG. 10.

FIG. 13 is a cross-sectional view illustrating a schematic configuration of a bipolar battery according to a fifth embodiment of the present invention.

FIG. 14 is an enlarged view of a portion indicated by an arrow Y in FIG. 13.

FIG. 15A is a cross-sectional view of a water sealing material used in the bipolar battery illustrated in FIG. 13, and FIG. 15B is a cross-sectional view of a common water sealing material used in the bipolar battery illustrated in FIG. 13.

FIG. 16 is a cross-sectional view illustrating a schematic configuration of a bipolar battery according to a sixth embodiment of the present invention.

FIG. 17 is an enlarged view of a portion indicated by an arrow Z in FIG. 16.

FIG. 18A is a cross-sectional view of the water sealing material used in the bipolar battery illustrated in FIG. 16, and FIG. 18B is a cross-sectional view of a common water sealing material used in the bipolar battery illustrated in FIG. 16.

### DETAILED DESCRIPTION

Embodiments of a bipolar battery according to the present invention will be described with reference to the drawings, but the present invention is not limited only to the following embodiments described with reference to the drawings.

### First Embodiment

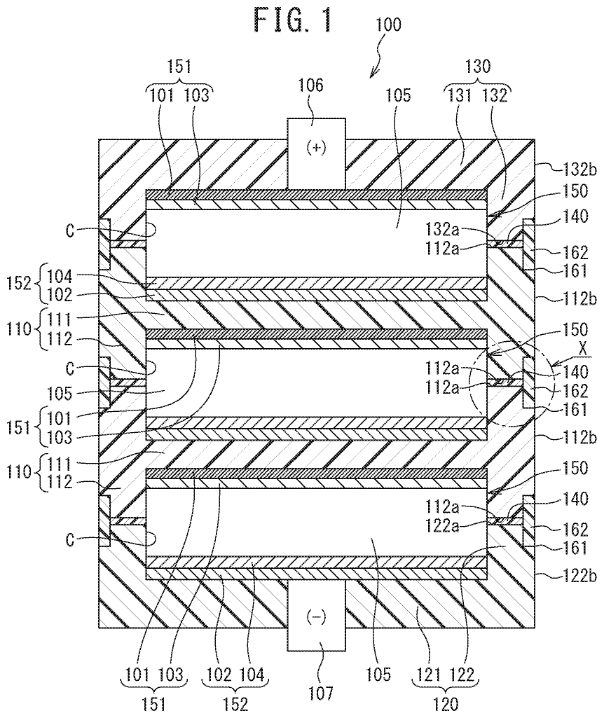

A bipolar battery according to a first embodiment of the present invention will be described with reference to FIGS. 1 to 3.

A bipolar battery 100 illustrated in FIG. 1 is a bipolar lead storage battery in which a positive electrode 151 has a positive electrode lead layer 101 and a negative electrode 152 has a negative electrode lead layer 102. The bipolar battery 100 includes a plurality of cell members 150, a plurality of internal frame units 110, a first end frame unit 120, and a second end frame unit 130.

The plurality of cell members 150 is stacked at intervals in the stacking direction (the vertical direction in FIG. 1).

The plurality of internal frame units 110, the first end frame unit 120, and the second end frame unit 130 form a plurality of cells C (also called spaces) that individually house the plurality of cell members 150.

Each of the internal frame units 110 is formed of a rectangular planar-shaped substrate 111 (e.g., a bipolar plate) and, for example, a quadrangular frame-shaped (picture frame-shaped) rim 112. The substrate 111 of the internal frame unit 110 is disposed between the cell members 150 adjacent to each other in the stacking direction (the vertical direction in FIG. 1) of the cell members 150. Each rim 112 of each of the internal frame units 110 includes joining surfaces 112a (e.g., one joining surface 112a and another joining surface 112a) facing each other in the stacking direction (the vertical direction in FIG. 1) of the cell members 150.

The substrate 111 is integrally formed inside the rim 112. The internal frame unit 110 is made of a thermoplastic resin having sulfuric acid resistance (e.g., polyethylene, polypropylene, polystyrene, polyvinyl chloride, polymethyl methacrylate (acrylic resin), acrylonitrile-butadiene-styrene copolymer (ABS), polyamide (nylon), or polycarbonate, or some combination thereof). The substrate 111 is positioned in the middle of the rim 112 in the thickness direction (the vertical direction in FIG. 1) of the rim. The rim 112 has a thickness greater than the thickness of the substrate 111.

The first end frame unit 120 is formed of a rectangular planar-shaped first end plate 121 and, for example, a quadrangular frame-shaped (picture frame-shaped) rim 122. The first end plate 121 is integrally formed inside the rim 122. The first end frame unit 120 is made of a thermoplastic resin having sulfuric acid resistance.

The first end frame unit 120 surrounds a side surface of the cell member 150 and a negative electrode 152 side at one end side (lower end side in FIG. 1) of the bipolar lead storage battery 100. The first end plate 121 surrounds the negative electrode 152 side of the cell member 150, and the rim 122 surrounds the side surface of the cell member 150.

The first end plate 121 is disposed in parallel to the substrate 111 of the internal frame unit 110, and the rim 122 is arranged to be in contact with the rim 112 of the internal frame unit 110 positioned adjacent thereto. In other words, the rim 122 includes a joining surface 122a facing the rim 112 of the internal frame unit 110 in the stacking direction (the vertical direction in FIG. 1) of the cell members 150.

The first end plate 121 has a thickness greater than the thickness of the substrate 111. The rim 122 has a thickness greater than the thickness of the first end plate 121. The first end plate 121 is positioned at one end (lower end in FIG. 1) of the rim 122 in the thickness direction (the vertical direction in FIG. 1) of the rim 122.

The second end frame unit 130 is formed of a rectangular planar-shaped second end plate 131 and, for example, a quadrangular frame-shaped (picture frame-shaped) rim 132. The second end plate 131 is integrally formed inside the rim 132. The second end frame unit 130 is made of a thermoplastic resin having sulfuric acid resistance.

The second end frame unit 130 surrounds the side surface of the cell member 150 and a positive electrode 151 side at the other end side (upper end side in FIG. 1) of the bipolar lead storage battery 100. The second end plate 131 surrounds the positive electrode 151 side of the cell member 150, and the rim 132 surrounds the side surface of the cell member 150.

The second end plate 131 is disposed in parallel to the substrate 111 of the internal frame unit 110, and the rim 132 is arranged to be in contact with the rim 112 of the internal frame unit 110 positioned adjacent thereto. In other words, the rim 132 includes a joining surface 132a facing the rim 112 of the internal frame unit 110 in the stacking direction (the vertical direction in FIG. 1) of the cell members 150.

The second end plate 131 has a thickness greater than the thickness of the substrate 111. The rim 132 has a thickness greater than the thickness of the second end plate 131. The second end plate 131 is positioned at the other end (upper end in FIG. 1) of the rim 132 in the thickness direction (the vertical direction in FIG. 1) of the rim 132.

A positive electrode lead layer 101 is disposed on one surface of the substrate 111. A negative electrode lead layer 102 is disposed on the other surface of the substrate 111. A positive active material layer 103 is disposed on the positive electrode lead layer 101. A negative active material layer 104 is disposed on the negative electrode lead layer 102.

Between the positive active material layer 103 and the negative active material layer 104 facing each other, an electrolyte layer 105 is disposed which is made of a glass fiber mat or the like impregnated with an electrolyte such as sulfuric acid.

A negative electrode lead layer 102 is disposed on the other surface of the first end plate 121. A negative active material layer 104 is disposed on the negative electrode lead layer 102 on the first end plate 121. Between the negative active material layer 104 on the first end plate 121 and the positive active material layer 103 on the substrate 111 facing the negative active material layer, an electrolyte layer 105 is disposed. The electrolyte layer 105 is made of a glass fiber mat or the like impregnated with an electrolyte such as sulfuric acid.

A positive electrode lead layer 101 is disposed on one surface of the second end plate 131. A positive active material layer 103 is disposed on the positive electrode lead layer 101 on the second end plate 131. Between the positive active material layer 103 on the second end plate 131 and the negative active material layer 104 on the substrate 111 facing the positive active material layer, an electrolyte layer 105 is disposed. The electrolyte layer 105 is made of a glass fiber mat or the like impregnated with an electrolyte such as sulfuric acid.

The negative electrode lead layer 102 on the first end plate 121 is provided with a negative electrode terminal 107 electrically conductive to the outside of the first end plate 121. The positive electrode lead layer 101 on the second end plate 131 is provided with a positive electrode terminal 106 electrically conductive to the outside of the second end plate 131.

In other words, the bipolar battery 100 according to the first embodiment includes the plurality of cell members 150 each including the positive electrode 151 having the positive active material layer 103, the negative electrode 152 having the negative active material layer 104, and the electrolyte layer 105 interposed between the positive electrode 151 and the negative electrode 152, and being stacked at intervals. The bipolar battery 100 according to the first embodiment also includes the plurality of frame units (the plurality of internal frame units 110, the first end frame unit 120, and the second end frame unit 130) forming the plurality of cells C individually housing the plurality of cell members 150.

The cell members 150 adjacent to each other in the stacking direction are electrically connected to each other in series. Therefore, the substrate 111 interposed between the cell members 150 adjacent to each other in the stacking direction includes a means for electrically connecting the positive electrode lead layer 101 and the negative electrode lead layer 102.

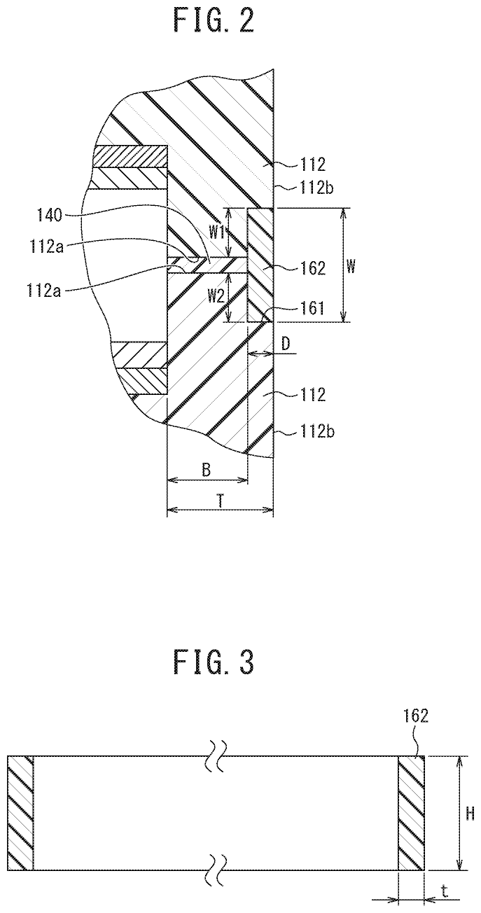

Each of the plurality of frame units (the plurality of internal frame units 110, the first end frame unit 120, and the second end frame unit 130) has joining surfaces 112a (e.g., one joining surface 112a and another joining surface 112a). Each of j oining surface 122a and joining surface 112a, and joining surface 132a and joining surface 112a, face each other in the stacking direction of the cell members 150, which are joined to each other by a joining material 140 (see FIG. 2).

Specifically, the joining surfaces 112a of the rims 112 of the internal frame units 110 adjacent to each other in the stacking direction, the joining surface 122a of the rim 122 of the first end frame unit 120 and the joining surface 112a of the rim 112 of the internal frame unit 110 adjacent to each other in the stacking direction, and the joining surface 132a of the rim 132 of the second end frame unit 130 and the joining surface 112a of the rim 112 of the internal frame unit 110 adjacent to each other in the stacking direction are joined to each other by the joining material 140 (see FIG. 2).

The joining material 140 is an adhesive or a fusing material.

The fusing material is a fusing material generated by vibration welding. For example, when the joining surfaces 112a of the rims 112 of the internal frame units 110 adjacent to each other are joined to each other, one joining surface 112a is pressed against the other joining surface 112a and vibrated to generate frictional heat. As a result, the one joining surface 112a and the other joining surface 112a are melted to generate melt, thereby forming a fusing material.

In the bipolar battery 100 configured as described above, the electrolyte layer 105 constituting the cell member 150 in the cell C is impregnated with an electrolyte. On the other hand, as described above, each of the plurality of frame units (the plurality of internal frame units 110, the first end frame unit 120, and the second end frame unit 130) has the joining surfaces 112a and 112a, 122a and 112a, and 132a and 112a facing each other in the stacking direction of the cell members 150, which are joined to each other by the joining material 140 (see FIG. 2). Specifically, the joining surfaces 112a, 122a, and 132a of the rims 112, 122, and 132 of the frame units (the internal frame unit 110, the first end frame unit 120, and the second end frame unit 130) adjacent to each other in the stacking direction are joined to each other by the joining material 140. Therefore, the electrolyte in the cell C can be prevented from leaking out from between the joining surfaces 112a, 122a, and 132a by the joining material 140.

However, depending on a joining mode of the joining material 140 between the joining surfaces 112a, 122a, and 132a, the electrolyte may leak out.

Therefore, in the bipolar battery 100 according to the first embodiment, on the outer side surfaces 112b, 122b, and 132b of the frame units (the internal frame unit 110, the first end frame unit 120, the second end frame unit 130), which are adjacent to each other in the stacking direction, grooves 161 are formed that communicate between the joining surfaces 112a, 122a, and 132a, which are to be joined, and open to outer side surfaces 112b, 122b, and 132b. A water sealing material 162 is disposed in the grooves 161.

Specifically, on the outer side surfaces 112b of the rims 112 of the internal frame units 110 adjacent to each other in the stacking direction, a groove 161 is formed that communicates between the joining surfaces 112a to be joined and opens to the outer side surfaces 112b. The water sealing material 162 is disposed in the groove 161.

Similarly, on the outer side surface 122b of the rim 122 of the first end frame unit 120 and the outer side surface 112b of the rim 112 of the internal frame unit 110, which are adjacent to each other in the stacking direction, a groove 161 is formed that communicates between the joining surfaces 122a and 112a to be joined and opens to the outer side surfaces 122b and 112b. The water sealing material 162 is disposed in the groove 161.

Similarly, on the outer side surface 132b of the rim 132 of the second end frame unit 130 and the outer side surface 112b of the rim 112 of the internal frame unit 110, which are adjacent to each other in the stacking direction, a groove 161 is formed that communicates between the joining surfaces 132a and 112a to be joined and opens to the outer side surfaces 132b and 112b. The water sealing material 162 is disposed in the groove 161.

As described above, for the bipolar battery 100 according to the first embodiment, on the outer side surfaces 112b, 122b, 132b of the frame units (the internal frame unit 110, the first end frame unit 120, and the second end frame unit 130) adjacent to each other in the stacking direction, grooves 161 are formed that communicate between the joining surfaces 112a, 122a, 132a to be joined and open to the outer side surfaces 112b, 122b, and 132b). The water sealing material 162 is disposed in the grooves 161.

Thus, even if the electrolyte leaking out of the cell C escapes the joining material 140 and leaks out from between the joining surfaces 112a, 122a, and 132a, the electrolyte is reliably prevented from leaking out from the frame units (the internal frame unit 110, the first end frame unit 120, and the second end frame unit 130) by the water sealing material 162.

In the bipolar battery 100 according to the first embodiment, the seal configuration may be simply made by joining the joining surfaces 112a, 122a, and 132a of the frame units (the internal frame unit 110, the first end frame unit 120, and the second end frame unit 130) adjacent to each other in the stacking direction by the joining material 140 and disposing the water sealing material 162 in the grooves 161 that are formed on the outer side surfaces 112b, 122b, and 132b of the frame units (the internal frame unit 110, the first end frame unit 120, and the second end frame unit 130). The grooves 161 communicate between the joining surfaces 112a, 122a, and 132a to be joined, and open to the outer side surfaces 112b, 122b, and 132b. Thereby, the seal configuration can be simplified.

Therefore, for the bipolar battery 100 according to the first embodiment, it is possible to provide the bipolar battery 100 capable of reliably preventing the electrolyte from leaking out of the cell C by a simple seal configuration.

In the bipolar battery 100 according to the first embodiment, each of the plurality of frame units (the internal frame unit 110, the first end frame unit 120, and the second end frame unit 130) includes the rims 112, 122, and 132 having the joining surfaces 112a, 122a, and 132a facing each other in the stacking direction of the cell members 150. The joining surfaces 112a, 122a, and 132a of the rims 112, 122, and 132 of the frame units adjacent to each other in the stacking direction are joined to each other by the joining material 140. The groove 161 is formed on the outer side surfaces 112b, 122b, 132b of rims 112, 122, and 132 of frame units adjacent to each other in the stacking direction, and the water sealing material 162 is disposed in the groove 161.

Thus, even if the electrolyte leaking from the cell C escapes the joining material 140 and leaks out from between the joining surfaces 112a, 122a, and 132a of the rim 112, 122, and 132, the electrolyte can be reliably prevented from leaking out from the frame units (the internal frame unit 110, the first end frame unit 120, and the second end frame unit 130) by the water sealing material 162.

The seal configuration may be made simply by joining the joining surfaces 112a, 122a, and 132a of the rims 112, 122, and 132 adjacent to each other in the stacking direction by the joining material 140 and disposing the water sealing material 162 in the grooves 161 that are formed on the outer side surfaces 112b, 122b, and 132b of the rims 112, 122, and 132). The grooves 161 communicate between the joining surfaces 112a, 122a, and 132a to be joined, and open to the outer side surfaces, whereby the seal configuration can be simplified.

The shape of each groove 161 will now be described with reference to FIG. 2, and the shape of each water sealing material 162 will now be described with reference to FIGS. 2 and 3. FIG. 2 illustrates an enlarged view of a portion indicated by an arrow X in FIG. 1, and illustrates the vicinity of the joining surfaces 112a of the rims 112 adjacent to each other in the stacking direction.

Because the shapes of the groove 161 communicating between the joining surfaces 112a and 112a to be joined, the groove 161 communicating between the joining surfaces 112a and 122a to be joined, and the groove 161 communicating between the joining surfaces 112a and 132a to be joined are all the same, only the shape of the groove 161 communicating between the joining surfaces 112a and 112a to be joined will be described, and the description of the shapes of the other grooves 161 will be omitted.

The cross-sectional shape of each groove 161 communicating between the joining surfaces 112a and 112a to be joined has a rectangular shape having a width Win the stacking direction (the vertical direction in FIG. 2) and a depth D in the direction orthogonal to the stacking direction (the horizontal direction in FIG. 2). Each groove 161 opens to the outer side surface 112b of each of the rims 112 and 112. Each groove 161 is formed in an endless shape over the entire circumference of the quadrangular frame-shaped (picture frame-shaped) rims 112.

Because the shapes of the water sealing material 162 disposed in the groove 161 communicating between the joining surfaces 112a and 112a to be joined, the water sealing material 162 disposed in the groove 161 communicating between the joining surfaces 112a and 122a to be joined, and the water sealing material 162 disposed in the groove 161 communicating between the joining surfaces 112a and 132a to be joined are all the same, only the shape of the water sealing material 162 disposed in the groove 161 communicating between the joining surfaces 112a and 112a to be joined will be described, and the description of the shapes of the other water sealing material 162 will be omitted.

As illustrated in FIGS. 2 and 3, the water sealing material 162 disposed in the groove 161 communicating between the joining surfaces 112a and 112a to be joined has a quadrangular frame shape having a shape complementary to that of the groove 161. In the cross-sectional shape of the water sealing material 162, a width H in the stacking direction has the same dimension as the width W in the stacking direction of the groove 161, and a thickness tin the direction orthogonal to the stacking direction has the same dimension as the depth D of the groove 161.

In the rim 112 on one side (the upper side in FIG. 2), the creepage distance in the groove 161 in contact with the water sealing material 162 (the distance from when the electrolyte passes between the joining surfaces 112a and 112a to when the electrolyte passes through the rims 112 and 112) is the sum of a stacking direction distance W1 in the groove 161 in contact with the water sealing material 162 and the distance (the distance equal to the thickness t of the water sealing material 162) in the groove 161 in contact with the water sealing material 162 in the direction orthogonal to the stacking direction.

In the rim 112 on the other side (the lower side in FIG. 2), the creepage distance in the groove 161 in contact with the water sealing material 162 (the distance from when the electrolyte passes between the joining surfaces 112a and 112a to when the electrolyte passes through the rims 112 and 112) is the sum of a stacking direction distance W2 in the groove 161 in contact with the water sealing material 162 and the distance (the distance equal to the thickness t of the water sealing material 162) in the groove 161 in contact with the water sealing material 162 in the direction orthogonal to the stacking direction.

The longer the creepage distance in the groove 161 in contact with the water sealing material 162, the greater the water sealing effect (the effect of suppressing the electrolyte from leaking out) by the water sealing material 162.

To increase the creepage distance, it is necessary to increase the stacking direction distances W1 and W2 or the thickness t of the water sealing material 162. But, if the thickness t of the water sealing material 162 is increased, it is necessary to increase the depth D of the groove 161. If the depth D of the groove 161 is increased, a joining width B of the joining material 140 at the joining surfaces 112a and 112a is reduced, and thus the water sealing effect of the joining material 140 is reduced. On the other hand, if the joining width B of the joining material 140 at the joining surfaces 112a and 112a is maintained in a state in which the depth D of the groove 161 is increased, a thickness T of the rim 112 is increased, and there is a problem in that the bipolar lead storage battery 100 is increased in size.

Therefore, to increase the creepage distance, it is preferable to increase the stacking direction distances W1 and W2. To increase the stacking direction distances W1 and W2, it is preferable that the width H in the stacking direction of the water sealing material 162 is increased larger than the thickness tin the direction orthogonal to the stacking direction of the water sealing material 162.

By increasing the width H in the stacking direction of the water sealing material 162 larger than the thickness tin the direction orthogonal to the stacking direction of the water sealing material 162 (H>t), it is possible to increase the creepage distance in the groove 161 in contact with the water sealing material 162 while maintaining the joining width B of the joining material 140 and the thickness T of the rim 112 at the joining surfaces 112a and 112a, thereby improving the water sealing effect.

The material of the water sealing material 162 will now be described. The material of the water sealing material 162 is the same for all of the water sealing material 162 disposed in the groove 161 communicating between the joining surfaces 112a and 112a to be joined, the water sealing material 162 disposed in the groove 161 communicating between the joining surfaces 112a and 122a to be joined, and the water sealing material 162 disposed in the groove 161 communicating between the joining surfaces 112a and 132a to be joined.

Each water sealing material 162 is preferably any of dope cement, hot melt, or a liquid gasket.

The dope cement is an adhesive obtained by dissolving a thermoplastic resin material in a solvent. When the dope cement is disposed in the groove 161, a liquid obtained by dissolving a thermoplastic resin material in a solvent may be poured into the groove 161 and dried to volatilize the solvent. Thus, the water sealing material 162 made of the dope cement is disposed in the groove 161 to be flush with the outer side surfaces 112b and 112b of the rims 112 and 112.

The hot melt is an adhesive obtained by applying heat to a resin material to liquefy the resin material. When the hot melt is disposed in the groove 161, the resin material may be heated to be liquefied, and the liquefied resin material may be poured into the groove 161 and then dried to be solidified. Thus, the water sealing material 162 made of the hot melt is disposed in the groove 161 to be flush with the outer side surfaces 112b and 112b of the rims 112 and 112.

Further, the liquid gasket is an adhesive that maintains a liquid state at normal temperature and forms an elastic film or an adhesive thin film when dried after application. When the liquid gasket is disposed in the groove 161, the liquid gasket may be poured into the groove 161 and dried to solidify. Thus, the water sealing material 162 made of the liquid gasket is disposed in the groove 161 to be flush with the outer side surfaces 112b and 112b of the rims 112 and 112.

As the resin material for the dope cement, ethylene-vinyl acetate copolymer (EVA) and acrylic resin are used in addition to the same resin as that of each frame unit.

The resin material of the dope cement may be the same as or different from the material of the rims 112, 122, and 132 having the grooves 161 in which the dope cement is disposed, but it is preferable if the resin material of the dope cement is the same as the material of the rims 112, 122, and 132 having the grooves 161 in which the dope cement is disposed because the resin material of the dope cement easily conforms to the rims 112, 122, and 132.

As the resin material for the hot melt, ethylene-vinyl acetate copolymer (EVA), acrylic resin, and synthetic rubber resin are used in addition to the same resin as that of each frame unit. The resin material of the hot melt may be the same as or different from the material of the rims 112, 122, and 132 having the grooves 161 in which the hot melt is disposed, but it is preferable if the resin material of the hot melt is the same as the material of the rims 112, 122, and 132 having the grooves 161 in which the hot melt is disposed because the resin material of the hot melt easily conforms to the rims 112, 122, and 132.

Further, as the resin material for the liquid gasket, silicone resin, acrylic resin, and synthetic rubber resin are used in addition to the same resin as that of each frame unit. The resin material of the liquid gasket may also be the same as or different from the material of the rims 112, 122, and 132 having the grooves 161 in which the liquid gasket is disposed, but it is preferable if the resin material of the liquid gasket is the same as the material of the rims 112, 122, and 132 having the grooves 161 in which the doped cement is disposed because the resin material of the liquid gasket easily conforms to the rims 112, 122, and 132.

As described above, for the bipolar battery 100 according to the first embodiment, because the water sealing material 162 is any of the dope cement, the hot melt, or the liquid gasket, the water sealing material 162 can be disposed in the groove 161 by a simple work process. The electrolyte can be reliably prevented from leaking out of the cell C.

### Second Embodiment

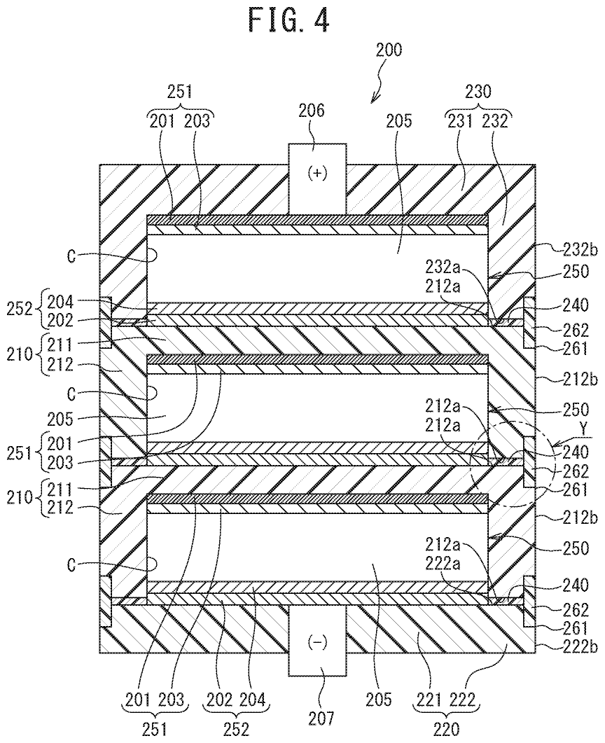

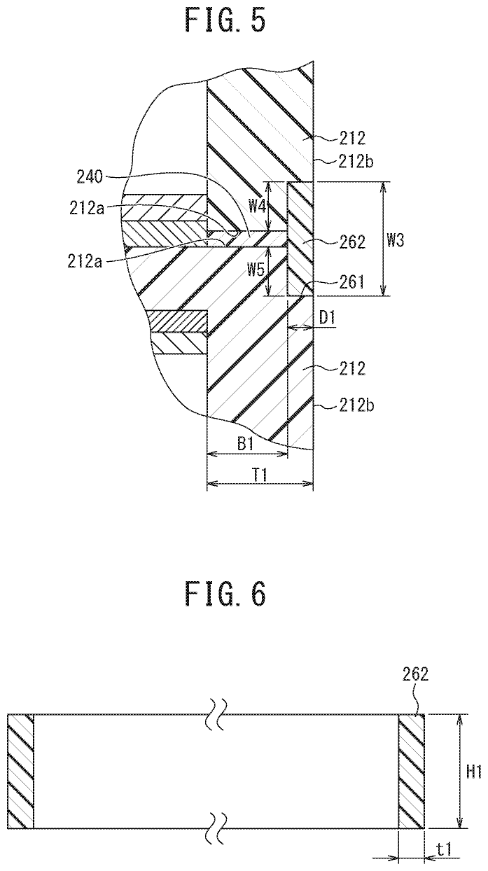

A bipolar battery according to a second embodiment of the present invention will now be described with reference to FIGS. 4 to 6. FIG. 4 is a cross-sectional view illustrating a schematic configuration of a bipolar battery according to the second embodiment of the present invention. FIG. 5 is an enlarged view of a portion indicated by an arrow Yin FIG. 4. FIG. 6 is a cross-sectional view of a water sealing material used in the bipolar battery illustrated in FIG. 4.

A bipolar battery 200 according to the second embodiment of the present invention illustrated in FIG. 4 is a bipolar lead storage battery in which a positive electrode 251 has a positive electrode lead layer 201 and a negative electrode 252 has a negative electrode lead layer 202. The bipolar battery 200 also includes a plurality of cell members 250, a plurality of internal frame units 210, a first end frame unit 220, and a second end frame unit 230.

The plurality of cell members 250 is stacked at intervals in the stacking direction (the vertical direction in FIG. 4).

The plurality of internal frame units 210, the first end frame unit 220, and the second end frame unit 230 form a plurality of cells C (also referred to as spaces) that individually house the plurality of cell members 250.

Each of the internal frame units 210 is formed of a rectangular planar-shaped substrate 211 (e.g., a bipolar plate) and, for example, a quadrangular frame-shaped (picture frame-shaped) rim 212. The substrate 211 of the internal frame unit 210 is disposed between the cell members 250 adjacent to each other in the stacking direction (the vertical direction in FIG. 4) of the cell members 250. Each rim 212 of each of the internal frame units 210 includes joining surfaces 212a (e.g., one joining surface 212a and another joining surface 212a) facing each other in the stacking direction (the vertical direction in FIG. 4) of the cell members 250.

The substrate 211 is integrally formed inside the rim 212. As with the internal frame unit 110, the internal frame unit 210 is made of a thermoplastic resin having sulfuric acid resistance. The substrate 211 is positioned at the other end (upper end) of the rim 212 in the thickness direction (the vertical direction in FIG. 4) of the rim 212. The rim 212 has a thickness greater than the thickness of the substrate 211.

The first end frame unit 220 is formed of a rectangular planar-shaped first end plate 221 and a rim 222 provided on the outer circumference of the first end plate 221. The first end plate 221 is integrally formed inside the rim 222. The first end frame unit 220 is made of a thermoplastic resin having sulfuric acid resistance.

The first end frame unit 220 surrounds a negative electrode 252 side of the cell member 250 at one end side (lower end side in FIG. 4) of the bipolar battery 200.

The first end plate 221 is disposed in parallel to the substrate 211 of the internal frame unit 210, and the rim 222 is arranged to be in contact with the rim 212 of the internal frame unit 210 positioned adjacent thereto. In other words, the rim 222 includes a joining surface 222a facing the rim 212 of the internal frame unit 210 in the stacking direction (the vertical direction in FIG. 4) of the cell members 250. The first end plate 221 has a thickness greater than the thickness of the substrate 211. The rim 222 has the same thickness as the thickness of the first end plate 221.

The second end frame unit 230 is formed of a rectangular planar-shaped second end plate 231 and, for example, a quadrangular frame-shaped (picture frame-shaped) rim 232. The second end plate 231 is integrally formed inside the rim 232. The second end frame unit 230 is made of a thermoplastic resin having sulfuric acid resistance.

The second end frame unit 230 surrounds a side surface of the cell member 250 and a positive electrode 251 side at the other end side (upper end side in FIG. 4) of the bipolar battery 200. The second end plate 231 surrounds the positive electrode 251 side of the cell member 250, and the rim 232 surrounds the side surface of the cell member 250.

The second end plate 231 is disposed in parallel with the substrate 211 of the internal frame unit 210, and the rim 232 is arranged to be in contact with the rim 212 of the internal frame unit 210 positioned adjacent thereto. In other words, the rim 232 includes a joining surface 232a facing the rim 212 of the internal frame unit 210 in the stacking direction (the vertical direction in FIG. 4) of the cell members 250.

The second end plate 231 has a thickness greater than the thickness of the substrate 211. The rim 232 has a thickness greater than the thickness of the second end plate 231. The second end plate 231 is set to be positioned at the other end (upper end in FIG. 4) of the rim 232 in the thickness direction (the vertical direction in FIG. 4) of the rim 232.

A positive electrode lead layer 201 is disposed on one surface of the substrate 211. A negative electrode lead layer 202 is disposed on the other surface of the substrate 211. A positive active material layer 203 is disposed on the positive electrode lead layer 201. A negative active material layer 204 is disposed on the negative electrode lead layer 202.

Between the positive active material layer 203 and the negative active material layer 204 facing each other, an electrolyte layer 205 is disposed that is made of a glass fiber mat or the like impregnated with an electrolyte such as sulfuric acid.

A negative electrode lead layer 202 is disposed on the other surface of the first end plate 221. A negative active material layer 204 is disposed on the negative electrode lead layer 202 on the first end plate 221. Between the negative active material layer 204 on the first end plate 221 and the positive active material layer 203 on the substrate 211 facing the negative active material layer, an electrolyte layer 205 is disposed that is made of a glass fiber mat or the like impregnated with an electrolyte such as sulfuric acid.

A positive electrode lead layer 201 is disposed on one surface of the second end plate 231. A positive active material layer 203 is disposed on the positive electrode lead layer 201 on the second end plate 231. Between the positive active material layer 203 on the second end plate 231 and the negative active material layer 204 on the substrate 211 facing the positive active material layer, an electrolyte layer 205 is disposed that is made of a glass fiber mat or the like impregnated with an electrolyte such as sulfuric acid.

The negative electrode lead layer 202 on the first end plate 221 is provided with a negative electrode terminal 207 electrically conductive to the outside of the first end plate 221. The positive electrode lead layer 201 on the second end plate 231 is provided with a positive electrode terminal 206 electrically conductive to the outside of the second end plate 231.

In other words, the bipolar battery 200 according to the second embodiment includes the plurality of cell members 250 each including the positive electrode 251 having the positive active material layer 203, the negative electrode 252 having the negative active material layer 204, and the electrolyte layer 205 interposed between the positive electrode 251 and the negative electrode 252, and being stacked at intervals. The bipolar battery 200 according to the second embodiment also includes the plurality of frame units (the plurality of internal frame units 210, the first end frame unit 220, and the second end frame unit 230) forming the plurality of cells C individually housing the plurality of cell members 250.

The cell members 250 adjacent to each other in the stacking direction are electrically connected to each other in series. Therefore, the substrate 211 interposed between the cell members 250 adjacent to each other in the stacking direction includes a means for electrically connecting the positive electrode lead layer 201 and the negative electrode lead layer 202.

Each of the plurality of frame units (the plurality of internal frame units 210, the first end frame unit 220, and the second end frame unit 230) has joining surfaces 212a and 212a, 222a and 212a, and 232a and 212a facing each other in the stacking direction of the cell members 250, which are joined to each other by a joining material 240 (see FIG. 5).

Specifically, the joining surfaces 212a of the rims 212 of the internal frame units 210 adjacent to each other in the stacking direction, the joining surface 222a of the rim 222 of the first end frame unit 220 and the joining surface 212a of the rim 212 of the internal frame unit 210 adjacent to each other in the stacking direction, and the joining surface 232a of the rim 232 of the second end frame unit 230 and the joining surface 212a of the rim 212 of the internal frame unit 210 adjacent to each other in the stacking direction are joined to each other by the joining material 240 (see FIG. 5). As with the joining material 140, the joining material 240 is an adhesive or a fusing material.

In the bipolar battery 200 configured as described above, the electrolyte layer 205 constituting the cell member 250 in the cell C is impregnated with an electrolyte. On the other hand, as described above, each of the plurality of frame units (the plurality of internal frame units 210, the first end frame unit 220, and the second end frame unit 230) has the joining surfaces 212a and 212a, 222a and 212a, and 232a and 212a facing each other in the stacking direction of the cell members 250, which are joined to each other by the joining material 240. Specifically, the joining surfaces 212a, 222a, and 232a of the rims 212, 222, and 232 of the frame units (the internal frame unit 210, the first end frame unit 220, and the second end frame unit 230) adjacent to each other in the stacking direction are joined to each other by the joining material 240. Therefore, the electrolyte in the cell C can be prevented from leaking out from between the joining surfaces 212a, 222a, and 232a by the joining material 240.

However, depending on a joining mode of the joining material 240 between the joining surfaces 212a, 222a, and 232a, the electrolyte may leak out.

Therefore, also in the bipolar battery 200 according to the second embodiment, on the outer side surfaces 212b, 222b, and 232b of the frame units (the internal frame unit 210, the first end frame unit 220, the second end frame unit 230) adjacent to each other in the stacking direction, grooves 261 are formed which communicate between the joining surfaces 212a, 222a, and 232a to be joined and open to outer side surfaces 212b, 222b, and 232b. A water sealing material 262 is disposed in the grooves 261.

Specifically, on the outer side surfaces 212b of the rims 212 of the internal frame units 210 adjacent to each other in the stacking direction, a groove 261 is formed that communicates between the joining surfaces 212a to be joined and opens to the outer side surfaces 212b. The water sealing material 262 is disposed in the groove 261.

Similarly, on the outer side surface 222b of the rim 222 of the first end frame unit 220 and the outer side surface 212b of the rim 212 of the internal frame unit 210, which are adjacent to each other in the stacking direction, a groove 261 is formed that communicates between the joining surfaces 222a and 212a to be joined and opens to the outer side surfaces 222b and 212b. The water sealing material 262 is disposed in the groove 261.

Similarly, on the outer side surface 232b of the rim 232 of the second end frame unit 230 and the outer side surface 212b of the rim 212 of the internal frame unit 210, which are adjacent to each other in the stacking direction, a groove 261 is formed that communicates between the joining surfaces 232a and 212a to be joined and opens to the outer side surfaces 232b and 212b. The water sealing material 262 is disposed in the groove 261.

Thus, even if the electrolyte leaking out of the cell C escapes the joining material 240 and leaks out from between the joining surfaces 212a, 222a, and 232a, the electrolyte is reliably prevented from leaking out from the frame units (the internal frame unit 210, the first end frame unit 220, and the second end frame unit 230) by the water sealing material 262.

Also, in the bipolar battery 200 according to the second embodiment, the seal configuration may be by simply joining the joining surfaces 212a, 222a, and 232a of the frame units (the internal frame unit 210, the first end frame unit 220, and the second end frame unit 230) adjacent to each other in the stacking direction by the joining material 240 and disposing the water sealing material 262 in the grooves 261, which are formed on the outer side surfaces 212b, 222b, and 232b of the frame units (the internal frame unit 210, the first end frame unit 220, and the second end frame unit 230). The grooves 261 communicate between the joining surfaces 212a, 222a, and 232a to be joined, and open to the outer side surfaces 212b, 222b, and 232b. Thereby, the seal configuration can be simplified.

Therefore, for the bipolar battery 200 according to the second embodiment, it is possible to provide the bipolar battery 200 capable of reliably preventing the electrolyte from leaking out of the cell C by a simple seal configuration.

In the bipolar battery 200 according to the second embodiment, each of the plurality of frame units (the internal frame unit 210, the first end frame unit 220, and the second end frame unit 230) includes the rims 212, 222, and 232 having the joining surfaces 212a, 222a, and 232a facing each other in the stacking direction of the cell members 250. The joining surfaces 212a, 222a, and 232a of the rims 212, 222, and 232 of the frame units adjacent to each other in the stacking direction are joined to each other by the joining material 240. The groove 261 is formed on the outer side surfaces 212b, 222b, 232b of rims 212, 222, and 232 of frame units adjacent to each other in the stacking direction, and the water sealing material 262 is disposed in the groove 261. Thus, even if the electrolyte leaking from the cell C escapes the joining material 240 and leaks out from between the joining surfaces 212a, 222a, and 232a of the rim 212, 222, and 232, the electrolyte can be reliably prevented from leaking out from the frame units (the internal frame unit 210, the first end frame unit 220, and the second end frame unit 230) by the water sealing material 262. The seal configuration may be formed simply by joining the joining surfaces 212a, 222a, and 232a of the rims 212, 222, and 232 adjacent to each other in the stacking direction by the joining material 240 and disposing the water sealing material 262 in the grooves 261, which are formed on the outer side surfaces 212b, 222b, and 232b of the rims 212, 222, and 232). The grooves 261 communicate between the joining surfaces 212a, 222a, and 232a to be joined, and open to the outer side surfaces, thereby the seal configuration can be simplified.

As with the cross-sectional shape of the groove 161, the cross-sectional shape of each groove 261 has a rectangular shape having a width W3 in the stacking direction (the vertical direction in FIG. 5) and a depth D1 in the direction orthogonal to the stacking direction (the horizontal direction in FIG. 5). Each groove 261 opens to the outer side surfaces 212b, 222b, and 232b of the rims 212, 222, and 232. Each groove 261 is formed in an endless shape over the entire circumference of the quadrangular shaped rims 212, 222, and 232.

Each water sealing material 262 has a quadrangular frame shape having a shape complementary to each groove 261. As with the cross-sectional shape of the water sealing material 162, for the cross-sectional shape of each water sealing material 262, by increasing the width H1 in the stacking direction of the water sealing material 262 larger than the thickness t1 in the direction orthogonal to the stacking direction of the water sealing material 262 (H1>t1), it is possible to increase the creepage distance (W4+t1 or W5+t1) in the groove 261 in contact with the water sealing material 262 while maintaining the joining width B1 of the joining material 240 at the joining surfaces 212a, 222a, and 232a and the thickness T1 of the rims 212, 222, and 232, thereby improving the water sealing effect.

As with the water sealing material 162, the material of the water sealing material 262 is preferably any of dope cement, hot melt, or a liquid gasket. Thus, for the bipolar battery 200 according to the second embodiment, because the water sealing material 262 is any of the dope cement, the hot melt, or the liquid gasket, the water sealing material 262 can be disposed in the groove 261 by a simple work process. The electrolyte can be reliably prevented from leaking out of the cell C.

### Third Embodiment

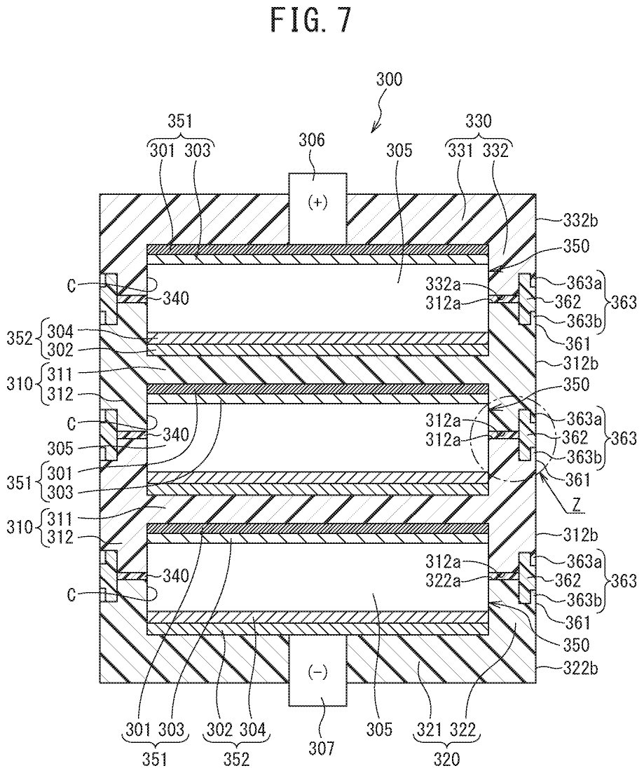

A bipolar battery according to a third embodiment of the present invention will now be described with reference to FIGS. 7 to 9.

As with the bipolar battery 100 according to the first embodiment, a bipolar battery 300 according to the third embodiment illustrated in FIG. 7 is a bipolar lead storage battery in which a positive electrode 351 has a positive electrode lead layer 301 and a negative electrode 352 has a negative electrode lead layer 302. The bipolar battery 300 includes a plurality of cell members 350, a plurality of internal frame units 310, a first end frame unit 320, and a second end frame unit 330.

The plurality of cell members 350 is stacked at intervals in the stacking direction (the vertical direction in FIG. 7).

The plurality of internal frame units 310, the first end frame unit 320, and the second end frame unit 330 form a plurality of cells C (also called spaces) that individually house the plurality of cell members 350.

As with the internal frame unit 110, each of the internal frame units 310 is formed of a rectangular planar-shaped substrate 311 (e.g., a bipolar plate) and, for example, a quadrangular frame-shaped (picture frame-shaped) rim 312. The substrate 311 of the internal frame unit 310 is disposed between the cell members 350 adjacent to each other in the stacking direction (the vertical direction in FIG. 7) of the cell members 350. Each rim 312 of each of the internal frame units 310 includes joining surfaces 312a (e.g., one joining surface 312a and another joining surface 312a) facing each other in the stacking direction (the vertical direction in FIG. 7) of the cell members 350.

The substrate 311 is integrally formed inside the rim 312. As with the internal frame unit 110, the internal frame unit 310 is made of a thermoplastic resin having sulfuric acid resistance. The substrate 311 is positioned in the middle of the rim 312 in the thickness direction (the vertical direction in FIG. 7) of the rim 312. The rim 312 has a thickness greater than the thickness of the substrate 311.

As with the first end frame unit 120, the first end frame unit 320 is formed of a rectangular planar-shaped first end plate 321 and a quadrangular frame-shaped (picture frame-shaped) rim 322. The first end plate 321 is integrally formed inside the rim 322. The first end frame unit 320 is made of a thermoplastic resin having sulfuric acid resistance.

The first end frame unit 320 surrounds a side surface of the cell member 350 and a negative electrode 352 side at one end side (lower end side in FIG. 7) of the bipolar battery 300. The first end plate 321 surrounds the negative electrode 352 side of the cell member 350, and the rim 322 surrounds the side surface of the cell member 350.

The first end plate 321 is disposed in parallel to the substrate 311 of the internal frame unit 310, and the rim 322 is arranged to be in contact with the rim 312 of the internal frame unit 310 positioned adjacent thereto. In other words, the rim 322 includes a joining surface 322a facing the rim 312 of the internal frame unit 310 in the stacking direction (the vertical direction in FIG. 7) of the cell members 350.

The first end plate 321 has a thickness greater than the thickness of the substrate 311. The rim 322 has a thickness greater than the thickness of the first end plate 321. The first end plate 321 is positioned at one end (lower end in FIG. 7) of the rim 322 in the thickness direction (the vertical direction in FIG. 7) of the rim 322.

The second end frame unit 330 is formed of a rectangular planar-shaped second end plate 331 and, for example, a quadrangular frame-shaped (picture frame-shaped) rim 332. The second end plate 331 is integrally formed inside the rim 332. The second end frame unit 330 is made of a thermoplastic resin having sulfuric acid resistance.

The second end frame unit 330 surrounds a side surface of the cell member 350 and a positive electrode 351 side at the other end side (upper end side in FIG. 7) of the bipolar battery 300. The second end plate 331 surrounds the positive electrode 351 side of the cell member 350, and the rim 332 surrounds the side surface of the cell member 350.

The second end plate 331 is disposed in parallel with the substrate 311 of the internal frame unit 310, and the rim 332 is arranged to be in contact with the rim 312 of the internal frame unit 310 positioned adjacent thereto. In other words, the rim 332 includes a joining surface 332a facing the rim 312 of the internal frame unit 310 in the stacking direction (the vertical direction in FIG. 7) of the cell members 350.

The second end plate 331 has a thickness greater than the thickness of the substrate 311. The rim 332 has a thickness greater than the thickness of the second end plate 331. The second end plate 331 is positioned at the other end (upper end in FIG. 7) of the rim 332 in the thickness direction (the vertical direction in FIG. 7) of the rim 332.

A positive electrode lead layer 301 is disposed on one surface of the substrate 311. A negative electrode lead layer 302 is disposed on the other surface of the substrate 311. A positive active material layer 303 is disposed on the positive electrode lead layer 301. A negative active material layer 304 is disposed on the negative electrode lead layer 302.

Between the positive active material layer 303 and the negative active material layer 304 facing each other, an electrolyte layer 305 is disposed that is made of a glass fiber mat or the like impregnated with an electrolyte such as sulfuric acid.

A negative electrode lead layer 302 is disposed on the other surface of the first end plate 321. A negative active material layer 304 is disposed on the negative electrode lead layer 302 on the first end plate 321. Between the negative active material layer 304 on the first end plate 321 and the positive active material layer 303 on the substrate 311 facing the negative active material layer, an electrolyte layer 305 is disposed that is made of a glass fiber mat or the like impregnated with an electrolyte such as sulfuric acid.

A positive electrode lead layer 301 is disposed on one surface of the second end plate 331. A positive active material layer 303 is disposed on the positive electrode lead layer 301 on the second end plate 331. Between the positive active material layer 303 on the second end plate 331 and the negative active material layer 304 on the substrate 311 facing the positive active material layer, an electrolyte layer 305 is disposed that is made of a glass fiber mat or the like impregnated with an electrolyte such as sulfuric acid.

The negative electrode lead layer 302 on the first end plate 321 is provided with a negative electrode terminal 307 electrically conductive to the outside of the first end plate 321. The positive electrode lead layer 301 on the second end plate 331 is provided with a positive electrode terminal 306 electrically conductive to the outside of the second end plate 331.

In other words, the bipolar battery 300 according to the third embodiment includes the plurality of cell members 350 each including the positive electrode 351 having the positive active material layer 303, the negative electrode 352 having the negative active material layer 304, and the electrolyte layer 305 interposed between the positive electrode 351 and the negative electrode 352, and being stacked at intervals. The bipolar battery 300 also includes the plurality of frame units (the plurality of internal frame units 310, the first end frame unit 320, and the second end frame unit 330) forming the plurality of cells C individually housing the plurality of cell members 350.

The cell members 350 adjacent to each other in the stacking direction are electrically connected to each other in series. Therefore, the substrate 311 interposed between the cell members 350 adjacent to each other in the stacking direction includes a means for electrically connecting the positive electrode lead layer 301 and the negative electrode lead layer 302.

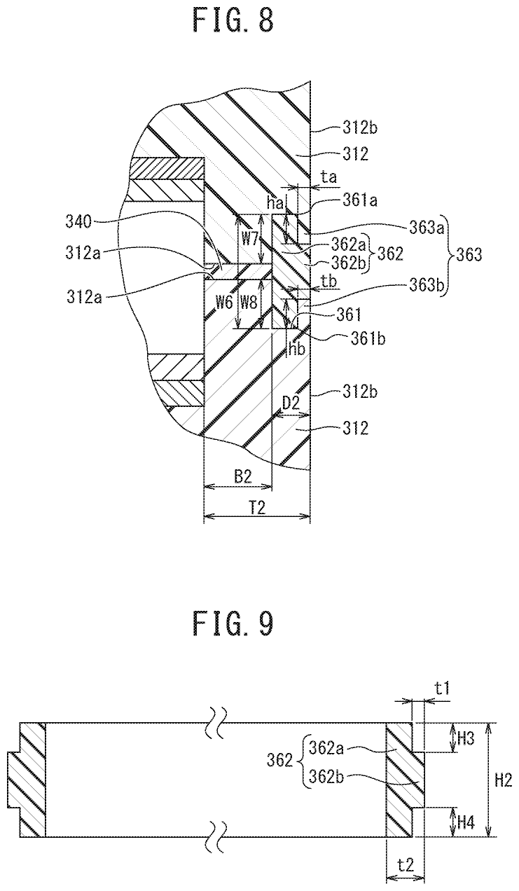

Each of the plurality of frame units (the plurality of internal frame units 310, the first end frame unit 320, and the second end frame unit 330) has joining surfaces 312a and 312a, 322a and 312a, and 332a and 312a facing each other in the stacking direction of the cell members 350, which are joined to each other by a joining material 340 (see FIG. 8). Specifically, the joining surfaces 312a of the rims 312 of the internal frame units 310 adjacent to each other in the stacking direction, the joining surface 322a of the rim 322 of the first end frame unit 320 and the joining surface 312a of the rim 312 of the internal frame unit 310 adjacent to each other in the stacking direction, and the joining surface 332a of the rim 332 of the second end frame unit 330 and the joining surface 312a of the rim 312 of the internal frame unit 310 adjacent to each other in the stacking direction are joined to each other by the joining material 340 (see FIG. 8).

As with the joining material 140, the joining material 340 is an adhesive or a fusing material. In the bipolar battery 300 configured as described above, the electrolyte layer 305 constituting the cell member 350 in the cell C is impregnated with an electrolyte. On the other hand, as described above, each of the plurality of frame units (the plurality of internal frame units 310, the first end frame unit 320, and the second end frame unit 330) has the joining surfaces 312a and 312a, 322a and 312a, and 332a and 312a facing each other in the stacking direction of the cell members 350, which are joined to each other by the joining material 340. Specifically, the joining surfaces 312a, 322a, and 332a of the rims 312, 322, and 332 of the frame units (the internal frame unit 310, the first end frame unit 320, and the second end frame unit 330) adjacent to each other in the stacking direction are joined to each other by the joining material 340. Thus, the electrolyte in the cell C can be prevented from leaking out from between the joining surfaces 312a, 322a, and 332a by the joining material 340.

However, depending on a joining mode of the joining material 340 between the joining surfaces 312a, 322a, and 332a, the electrolyte may leak out.

Therefore, also in the bipolar battery 300 according to the third embodiment, on the outer side surfaces 312b, 322b, and 332b of the frame units (the internal frame unit 310, the first end frame unit 320, the second end frame unit 330) adjacent to each other in the stacking direction, grooves 361 are formed that communicate between the joining surfaces 312a, 322a, and 332a to be joined and open to outer side surfaces 312b, 322b, and 332b. A water sealing material 362 is disposed in the grooves 361.

Specifically, on the outer side surfaces 312b and 312b of the rims 312 and 312 of the internal frame units 310 and 310 adjacent to each other in the stacking direction, a groove 361 is formed that communicates between the joining surfaces 312a and 312a to be joined and opens to the outer side surfaces 312b and 312b. The water sealing material 362 is disposed in the groove 361.

Similarly, on the outer side surface 322b of the rim 322 of the first end frame unit 320 and the outer side surface 312b of the rim 312 of the internal frame unit 310, which are adjacent to each other in the stacking direction, a groove 361 is formed that communicates between the joining surfaces 322a and 312a to be joined and opens to the outer side surfaces 322b and 312b. The water sealing material 362 is disposed in the groove 361.

Similarly, on the outer side surface 332b of the rim 332 of the second end frame unit 330 and the outer side surface 312b of the rim 312 of the internal frame unit 310, which are adjacent to each other in the stacking direction, a groove 361 is formed that communicates between the joining surfaces 332a and 312a to be joined and opens to the outer side surfaces 332b and 312b. The water sealing material 362 is disposed in the groove 361.

Thus, even if the electrolyte leaking out of the cell C escapes the joining material 340 and leaks out from between the joining surfaces (joining surface 312a, joining surface 322a, and joining surface 332a), the electrolyte is reliably prevented from leaking out from the frame units (the internal frame unit 310, the first end frame unit 320, and the second end frame unit 330) by the water sealing material 362.

Also in the bipolar battery 300 according to the third embodiment, the seal configuration may be formed simply by joining the joining surfaces 312a, 322a, and 332a of the frame units (the internal frame unit 310, the first end frame unit 320, and the second end frame unit 330) adjacent to each other in the stacking direction by the joining material 340 and disposing the water sealing material 362 in the grooves 361, which are formed on the outer side surfaces 312b, 322b, and 332b of the frame units (the internal frame unit 310, the first end frame unit 320, and the second end frame unit 330). The grooves 361 communicate between the joining surfaces 312a, 322a, and 332a to be joined, and open to the outer side surfaces 312b, 322b, and 332b). Thereby, the seal configuration can be simplified.

Therefore, for the bipolar battery 300 according to the third embodiment, it is possible to provide the bipolar battery 300 capable of reliably preventing the electrolyte from leaking out of the cell C by a simple seal configuration.

In the bipolar battery 300 according to the third embodiment, each of the plurality of frame units (the internal frame unit 310, the first end frame unit 320, and the second end frame unit 330) includes the rims 312, 322, and 332 having the joining surfaces 312a, 322a, and 332a facing each other in the stacking direction of the cell members 350. The joining surfaces 312a, 322a, and 332a of the rims 312, 322, and 332 of the frame units adjacent to each other in the stacking direction are joined to each other by the joining material 340. The groove 361 is formed on the outer side surfaces 312b, 322b, 332b of rims 312, 322, and 332 of frame units adjacent to each other in the stacking direction, and the water sealing material 362 is disposed in the groove 361. Thus, even if the electrolyte leaking from the cell C escapes the joining material 340 and leaks out from between the joining surfaces 312a, 322a, and 332a of the rim 312, 322, and 332, the electrolyte can be reliably prevented from leaking out from the frame units (the internal frame unit 310, the first end frame unit 320, and the second end frame unit 330) by the water sealing material 362. The seal configuration may be formed simply by joining the joining surfaces 312a, 322a, and 332a of the rims 312, 322, and 332 adjacent to each other in the stacking direction by the joining material 340 and disposing the water sealing material 362 in the grooves 361, which are formed on the outer side surfaces 312b, 322b, and 332b of the rims 312, 322, and 332). The grooves 361 communicate between the joining surfaces 312a, 322a, and 332a to be joined, and open to the outer side surfaces. Thereby the seal configuration can be simplified.

In the bipolar battery 300 according to the third embodiment, as illustrated in FIGS. 7 and 8, open ends 361a and 361b of each groove 361 are provided with protrusions 363 protruding from the open ends 361a and 361b.

Specifically, at the open end 361a on one side (upper side in FIG. 8) in the stacking direction (the vertical direction in FIG. 8) of each groove 361, a one-side protrusion 363a is formed that protrudes from the open end 361a on the one side toward the open end 361b on the other side (lower side in FIG. 8), and at the open end 361b on the other side, an other-side protrusion 363b is formed that protrudes from the open end 361b on the other side toward the open end 361a on one side. The one-side protrusion 363a and the other-side protrusion 363b constitute the protrusion 363.

For the bipolar battery 300 according to the third embodiment, by providing the open ends 361a and 361b of each groove 361 with the protrusions 363 protruding from the open ends 361a and 361b, the water sealing material 362 disposed in each groove 361 can be retained and positioned, and the water sealing material 362 can be suppressed from leaking out when the liquid water sealing material 362 before being solidified is poured into the groove 361. The protrusion 363 can improve an effect of preventing the electrolyte from leaking out.

The shape of each groove 361, the shape of each protrusion 363, and the shape of each water sealing material 362 will now be described with reference to FIGS. 8 and 9. FIG. 8 illustrates an enlarged state of a portion indicated by an arrow Z in FIG. 7, and illustrates the vicinity of the joining surfaces 312a and 312a of the rims 312 and 312 adjacent to each other in the stacking direction.

Because the shapes of the groove 361 communicating between the joining surfaces 312a and 312a to be joined, the groove 361 communicating between the joining surfaces 312a and 322a to be joined, and the groove 361 communicating between the joining surfaces 312a and 332a to be joined are all the same, only the shape of the groove 361 communicating between the joining surfaces 312a and 312a to be joined will be described, and the description of the shapes of the other grooves 361 will be omitted. Because the shapes of the protrusions 363 provided in all the grooves 361 are all the same, only the shape of the protrusion 363 provided in the groove 361 communicating between the joining surfaces 312a and 312a to be joined will be described. Because the shapes of the water sealing material 362 disposed in all the grooves 361 are all the same, only the shape of the water sealing material 362 disposed in the groove 361 communicating between the joining surfaces 312a and 312a to be joined will be described.

The cross-sectional shape of each groove 361 communicating between the joining surfaces 312a and 322a to be joined has a shape obtained by subtracting the one-side protrusion 363a and the other-side protrusion 363b from a rectangular shape having a width W6 in the stacking direction (the vertical direction in FIG. 8) and a depth D2 in the direction orthogonal to the stacking direction (the horizontal direction in FIG. 8). Each groove 361 opens to the outer side surface 312b of each of the rims 312 and 312. Each groove 361 is formed in an endless shape over the entire circumference of the quadrangular shaped rims 312 and 312.

The one-side protrusion 363a of the protrusion 363 has a width to and protrudes by a protruding length ha from the open end 361a on one side (upper side in FIG. 8) in the stacking direction of the groove 361 toward the open end 361b on the other side (lower side in FIG. 8).

The other-side protrusion 363b of the protrusion 363 has a width tb and protrudes by a protruding length hb from the open end 361b on the other side in the stacking direction of the groove 361 toward the open end 361a on the one side.

The one-side protrusion 363a and the other-side protrusion 363b constituting the protrusion 363 are formed in an endless shape over the entire circumference of the quadrangular shaped rims 312 and 312 in accordance with the groove 361.

As illustrated in FIGS. 8 and 9, the water sealing material 362 disposed in the groove 361 communicating between the joining surfaces 312a and 312a to be joined has a quadrangular frame shape having a shape complementary to that of the groove 361 provided with the protrusion 363. The cross-sectional shape of the water sealing material 362 includes a rectangular first portion 362a and a rectangular second portion 362b that is in contact with the first portion 362a and is smaller than the first portion 362a.

A width H2 in the stacking direction of the first portion 362a of the water sealing material 362 has the same dimension as the width W6 in the stacking direction of the groove 361, and a thickness t2 in the direction orthogonal to the stacking direction of a combination of the first portion 362a and the second portion 362b of the water sealing material 362 has the same dimension as the depth D2 of the groove 361. The width in the stacking direction of the second portion 362b of the water sealing material 362 has a dimension obtained by subtracting, from the width H2 in the stacking direction of the first portion 362a, a H3 equal to the protruding length ha of the one-side protrusion 363a provided in the groove 361 and the H2 equal to the protruding length hb of the other-side protrusion 363b. The second portion 362b of the water sealing material 362 has a thickness t1 in the direction orthogonal to the stacking direction.

In the rim 312 on one side (upper side in FIG. 8), the creepage distance in the groove 361 in contact with the water sealing material 362 (the distance from when the electrolyte passes between the joining surfaces 312a and 312a to when the electrolyte passes through the rims 312 and 312) is the sum of a stacking direction distance W7 in the groove 361 in contact with the water sealing material 362, the distance in the direction orthogonal to the stacking direction in the groove 361 in contact with the water sealing material 362 (the distance equal to the thickness t2 of the water sealing material 362), and the protruding length ha of the one-side protrusion 363a.

In the rim 312 on the other side (lower side in FIG. 8), the creepage distance in the groove 361 in contact with the water sealing material 362 (the distance from when the electrolyte passes between the joining surfaces 312a and 312a to when the electrolyte passes through the rims 312 and 312) is the sum of a stacking direction distance W8 in the groove 361 in contact with the water sealing material 362, the distance in the direction orthogonal to the stacking direction in the groove 361 in contact with the water sealing material 362 (the distance equal to the thickness t2 of the water sealing material 362), and the protruding length hb of the other-side protrusion 363b.

The longer the creepage distance in the groove 361 in contact with the water sealing material 362, the greater the water sealing effect (the effect of suppressing the electrolyte from leaking out) by the water sealing material 362.

To increase the creepage distance, it is necessary to increase the stacking direction distances W7 and W8, the thickness t2 of the water sealing material 362, or the protruding lengths ha and hb. But, if the thickness t2 of the water sealing material 362 is increased, it is necessary to increase the depth D2 of the groove 361. If the depth D2 of the groove 361 is increased, the joining width B2 of the joining material 340 at the joining surfaces 312a and 312a is reduced, and thus the water sealing effect of the joining material 340 is reduced. On the other hand, if the joining width B2 of the joining material 340 at the joining surfaces 312a and 312a is maintained in a state in which the depth D2 of the groove 361 is increased, a thickness T2 of the rim 312 is increased, and there is a problem in that the bipolar battery 300 is increased in size.

Therefore, to increase the creepage distance, it is preferable to increase the stacking direction distances W7 and W8. To increase the stacking direction distances W7 and W8, it is preferable that the width H2 in the stacking direction of the water sealing material 362 is increased larger than the thickness t2 in the direction orthogonal to the stacking direction of the water sealing material 362.

By increasing the width H2 in the stacking direction of the water sealing material 362 larger than the thickness t2 in the direction orthogonal to the stacking direction of the water sealing material 362 (H2>t2), it is possible to increase the creepage distance in the groove 361 in contact with the water sealing material 362 while maintaining the joining width B2 of the joining material 340 and the thickness T2 of the rim 312 at the joining surfaces 312a, thereby improving the water sealing effect.

As with the water sealing material 162, the material of the water sealing material 362 is preferably any of dope cement, hot melt, or a liquid gasket, or some combination thereof. Thus, for the bipolar battery 300 according to the third embodiment, because the water sealing material 362 is any of the dope cement, the hot melt, or the liquid gasket, the water sealing material 362 can be disposed in the groove 361 by a simple work process. The electrolyte can be reliably prevented from leaking out of the cell C.

### Fourth Embodiment

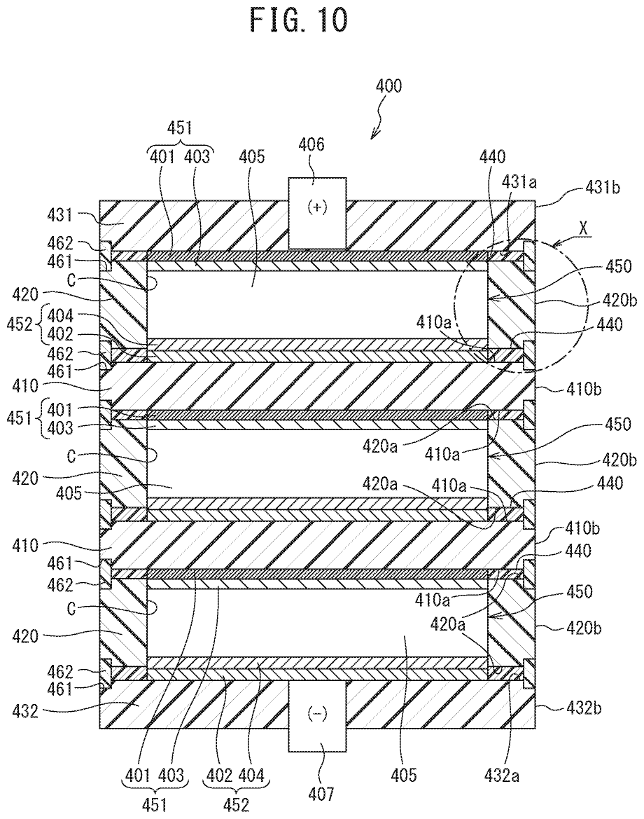

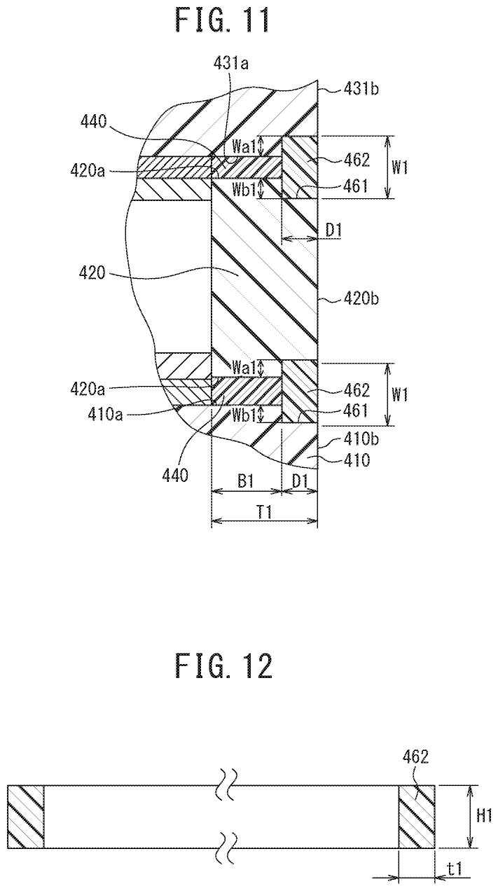

A bipolar battery according to a fourth embodiment of the present invention will be described with reference to FIGS. 10 and 11.

A bipolar battery 400 illustrated in FIG. 10 is a bipolar lead storage battery in which a positive electrode 451 has a positive electrode lead layer 401 and a negative electrode 452 has a negative electrode lead layer 402. The bipolar battery 400 includes a plurality of cell members 450, and a plurality of frame units (a plurality of bipolar plates 410, a first end plate 431, a second end plate 432, and a plurality of spacers 420) forming a plurality of cells C (spaces) individually housing the plurality of cell members 450. In the present embodiment, there are three cell members 450, and the plurality of frame members includes two bipolar plates 410, the first end plate 431, the second end plate 432, and three spacers 420 forming three cells C individually housing the three cell members 450.

The plurality of cell members 450 is stacked at intervals in the stacking direction (the vertical direction in FIG. 10). As illustrated in FIG. 10, each cell member 450 includes the positive electrode 451 having a positive active material layer 403, the negative electrode 452 having a negative active material layer 404, and an electrolyte layer 405 interposed between the positive electrode 451 and the negative electrode 452.

The plurality of frame units includes the plurality of bipolar plates 410 disposed between the cell members 450 adjacent to each other in the stacking direction, the first end plate 431 disposed at one end (upper end in FIG. 10) in the stacking direction of the plurality of cell members 450, the second end plate 432 disposed at the other end (lower end in FIG. 10) in the stacking direction of the plurality of cell members 450, and the plurality of spacers 420 disposed between the bipolar plates 410 adjacent to each other in the stacking direction, between the first end plate 431 and the bipolar plate 410, and between the second end plate 432 and the bipolar plate 410.

The plurality of cells C individually housing the plurality of cell members 450 is formed by the plurality of bipolar plates 410, the first end plate 431 and the second end plate 432, and the plurality of spacers 420.

Each bipolar plate 410 has a quadrangular planar shape. Each bipolar plate 410 has a flat plate shape in which the negative electrode 452 is disposed on one surface (upper surface in FIG. 10) in the stacking direction and the positive electrode 451 is disposed on the other surface (lower surface in FIG. 10) in the stacking direction. Each bipolar plate 410 is disposed between the cell members 450 adjacent to each other in the stacking direction (the vertical direction in FIG. 10) of the cell members 450. Each bipolar plate 410 has a joining surface 410a formed on each of an outer circumference portion of the negative electrode 452 on one surface in the stacking direction and an outer circumference portion of the positive electrode 451 on the other surface in the stacking direction. The joining surface 410a on one surface side in the stacking direction of the bipolar plate 410 is in contact with the spacer 420 adjacent to each other at the one surface side in the stacking direction of the bipolar plate 410, and the joining surface 410a on the other surface side in the stacking direction of the bipolar plate 410 is in contact with the spacer 420 adjacent to each other at the other surface side in the stacking direction of the bipolar plate 410. In other words, each bipolar plate 410 includes two joining surfaces 410a facing the two spacers 420 in the stacking direction of the cell members 450. The plate thickness of each bipolar plate 410 is set as appropriate.

Each bipolar plate 410 is made of a thermoplastic resin having sulfuric acid resistance (e.g., polyethylene, polypropylene, polystyrene, polyvinyl chloride, polymethyl methacrylate (acrylic resin), acrylonitrile-butadiene-styrene copolymer (ABS), polyamide (nylon), or polycarbonate, or some combination thereof).

The first end plate 431 is disposed at one end (upper end in FIG. 10) in the stacking direction of the plurality of cell members 450 and has a flat plate shape having a quadrangular planar shape. The first end plate 431 is made of a thermoplastic resin having sulfuric acid resistance. The first end plate 431 has a plate thickness greater than the plate thickness of the bipolar plate 410.

The first end plate 431 covers the positive electrode 451 of the cell member 450 at one end side (upper end side in FIG. 10) in the stacking direction of the bipolar battery 400.

The first end plate 431 is disposed in parallel to the bipolar plate 410 and has a joining surface 431a formed at the outer circumference portion of the other surface (lower surface in FIG. 10) in the stacking direction of the first end plate. The joining surface 431a is in contact with the spacer 420 adjacent to each other at the other surface side in the stacking direction of the first end plate 431. In other words, the first end plate 431 includes the joining surface 431a facing the spacer 420 in the stacking direction of the cell members 450.

The second end plate 432 is disposed at the other end (lower end in FIG. 10) in the stacking direction of the plurality of cell members 450 and has a flat plate shape having a quadrangular planar shape. The second end plate 432 is made of a thermoplastic resin having sulfuric acid resistance. The second end plate 432 has a plate thickness greater than the plate thickness of a bipolar plate 410.

The second end plate 432 covers the negative electrode 452 of the cell member 450 at the other end side (lower end side in FIG. 10) in the stacking direction of the bipolar battery 400.

The second end plate 432 is disposed in parallel with the bipolar plate 410 and has a joining surface 432a formed at the outer circumference portion of one surface (upper surface in FIG. 10) in the stacking direction of the second end plate. The joining surface 432a is in contact with the spacer 420 adjacent to each other at one surface side in the stacking direction of the second end plate 432. In other words, the second end plate 432 includes the joining surface 432a facing the spacer 420 in the stacking direction of the cell members 450.

The spacers 420 are respectively disposed between the bipolar plates 410 adjacent to each other in the stacking direction, between the first end plate 431 and the bipolar plate 410, and between the second end plate 432 and the bipolar plate 410.

The spacer 420 disposed between the bipolar plates 410 adjacent to each other in the stacking direction is formed in a quadrangular frame shape to surround the side surface of the cell member 450. The spacer 420 is made of a thermoplastic resin having sulfuric acid resistance. The spacer 420 has a plate thickness greater than the plate thickness of the bipolar plate 410.

The spacer 420 is disposed in parallel with the bipolar plate 410 and has a joining surface 420a formed on one surface (upper surface in FIG. 10) in the stacking direction of the spacer. The joining surface 420a is in contact with the bipolar plate 410 adjacent to each other at one surface side in the stacking direction. The spacer 420 has a joining surface 420a also formed on the other surface (lower surface in FIG. 10) in the stacking direction of the spacer. The joining surface 420a is in contact with the bipolar plate 410 adjacent to each other at the other surface side in the stacking direction. In other words, the spacer 420 includes two joining surfaces 420a facing the two bipolar plates 410 in the stacking direction of the cell members 450.

The spacer 420 disposed between the first end plate 431 and the bipolar plate 410 is formed in a quadrangular frame shape to surround the side surface of the cell member 450. The spacer 420 is made of a thermoplastic resin having sulfuric acid resistance. The spacer 420 has a plate thickness greater than the plate thickness of the bipolar plate 410.

The spacer 420 is disposed in parallel with the bipolar plate 410 and has a joining surface 420a formed on one surface (upper surface in FIG. 10) in the stacking direction. The joining surface 420a is in contact with the first end plate 431 adjacent to each other at one surface side in the stacking direction. The spacer 420 has a joining surface 420a also formed on the other surface (lower surface in FIG. 10) in the stacking direction of the spacer. The joining surface 420a is in contact with the bipolar plate 410 adjacent to each other at the other surface side in the stacking direction. In other words, the spacer 420 includes two joining surfaces 420a facing the first end plate 431 and the bipolar plate 410 in the stacking direction (the vertical direction in FIG. 10) of the cell members 450.

Further, the spacer 420 disposed between the second end plate 432 and the bipolar plate 410 is formed in a quadrangular frame shape to surround the side surface of the cell member 450. The spacer 420 is made of a thermoplastic resin having sulfuric acid resistance. The spacer 420 has a plate thickness greater than the plate thickness of the bipolar plate 410.

The spacer 420 is disposed in parallel with the bipolar plate 410 and has a joining surface 420a formed on one surface (upper surface in FIG. 10) in the stacking direction. The joining surface 420a is in contact with the bipolar plate 410 adjacent to each other at one side in the stacking direction. The spacer 420 has a joining surface 420a also formed on the other surface (lower surface in FIG. 10) in the stacking direction. The joining surface 420a is in contact with the second end plate 432 adjacent to each other at the other side in the stacking direction. In other words, the spacer 420 includes two joining surfaces 420a facing the bipolar plate 410 and the second end plate 432 in the stacking direction (the vertical direction in FIG. 10) of the cell members 450.

A negative electrode lead layer 402 is disposed on one surface in the stacking direction of the bipolar plate 410. A positive electrode lead layer 401 is disposed on the other surface in the stacking direction of the bipolar plate 410. A negative active material layer 404 is disposed on the negative electrode lead layer 402 to form a negative electrode 452. A positive active material layer 403 is disposed on the positive electrode lead layer 401 to form a positive electrode 451.

Between the positive active material layer 403 and the negative active material layer 404 facing each other, an electrolyte layer 405 is disposed. The electrolyte layer 405 is made of a glass fiber mat or the like impregnated with an electrolyte such as sulfuric acid.

A positive electrode lead layer 401 is disposed on the other surface in the stacking direction of the first end plate 431. A positive active material layer 403 is disposed on the positive electrode lead layer 401 on the first end plate 431 to form a positive electrode 451. Between the positive active material layer 403 on the first end plate 431 and the negative active material layer 404 of the bipolar plate 410 facing the positive active material layer, an electrolyte layer 405 is disposed. The electrolyte layer 405 is made of a glass fiber mat or the like impregnated with an electrolyte such as sulfuric acid.

A negative electrode lead layer 402 is disposed on one surface in the stacking direction of the second end plate 432. A negative active material layer 404 is disposed on the negative electrode lead layer 402 on the second end plate 432 to form a negative electrode 452. Between the negative active material layer 404 on the second end plate 432 and the positive active material layer 403 of the bipolar plate 410 facing the negative active material layer, an electrolyte layer 405 is disposed. The electrolyte layer 405 is made of a glass fiber mat or the like impregnated with an electrolyte such as sulfuric acid.

The positive electrode lead layer 401 on the first end plate 431 is provided with a positive electrode terminal 406 electrically conductive to the outside of the first end plate 431. The negative electrode lead layer 402 on the second end plate 432 is provided with a negative electrode terminal 407 electrically conductive to the outside of the second end plate 432.

In other words, the bipolar battery 400 according to the fourth embodiment includes the plurality of cell members 450 each including the positive electrode 451 having the positive active material layer 403, the negative electrode 452 having the negative active material layer 404, and the electrolyte layer 405 interposed between the positive electrode 451 and the negative electrode 452, and the plurality of frame units (a plurality of bipolar plates 410, the first end plate 431, the second end plate 432, and the plurality of spacers 420) forming the plurality of cells C (also called spaces) individually housing the plurality of cell members 450.

The plurality of frame units includes the plurality of bipolar plates 410 disposed between the cell members 450 adjacent to each other in the stacking direction, the first end plate 431 disposed at one end (upper end in FIG. 10) in the stacking direction of the plurality of cell members 450, the second end plate 432 disposed at the other end (lower end in FIG. 10) in the stacking direction of the plurality of cell members 450, and the plurality of spacers 420 disposed between the bipolar plates 410 adjacent to each other in the stacking direction, between the first end plate 431 and the bipolar plate 410, and between the second end plate 432 and the bipolar plate 410.

The plurality of cells C individually housing the plurality of cell members 450 is formed by the plurality of bipolar plates 410, the first end plate 431, and the second end plate 432, and the plurality of spacers 420.

The cell members 450 adjacent to each other in the stacking direction are electrically connected to each other in series. Therefore, the bipolar plate 410 interposed between the cell members 450 adjacent to each other in the stacking direction includes a means for electrically connecting the positive electrode lead layer 401 and the negative electrode lead layer 402.

Each of the plurality of frame units (the plurality of bipolar plates 410, the first end plate 431, the second end plate 432, and the plurality of spacers 420) has the joining surfaces 431a and 420a, 420a and 410a, 410a and 420a, 420a and 410a, 410a and 420a, and 420a and 432a facing each other in the stacking direction of the cell members 450, which are joined to each other by a joining material 440 (see FIG. 11).

Specifically, the joining surface 431a formed on the other surface in the stacking direction of the first end plate 431 and the joining surface 420a formed on one surface in the stacking direction of the spacer 420, which are adjacent to each other in the stacking direction, are joined to each other by the joining material 440. The joining surface 410a formed on one surface in the stacking direction of all the bipolar plates 410 and the joining surface 420a formed on the other surface in the stacking direction of all the spacers 420, which are adjacent to each other in the stacking direction, are also joined to each other by the joining material 440. The joining surface 410a formed on the other surface in the stacking direction of all the bipolar plates 410 and the joining surface 420a formed on one surface in the stacking direction of all the spacers 420, which are adjacent to each other in the stacking direction, are also joined to each other by the joining material 440. Further, the joining surface 432a formed on one surface in the stacking direction of the second end plate 432 and the joining surface 420a formed on the other surface in the stacking direction of the spacer 420, which are adjacent to each other in the stacking direction, are also joined to each other by the joining material 440.

The joining material 440 is an adhesive or a fusing material.

The fusing material is a fusing material generated by vibration welding. For example, when the joining surface 431a formed on the other surface in the stacking direction of the first end plate 431 and the joining surface 420a formed on one surface in the stacking direction of the spacer 420 are joined to each other, one joining surface 431a is pressed against the other joining surface 420a and vibrated to generate frictional heat. In this way, the one joining surface 431a and the other joining surface 420a are melted to generate melt, thereby forming a fusing material.

In the bipolar battery 400 configured as described above, the electrolyte layer 405 constituting the cell member 450 in the cell C is impregnated with an electrolyte.

On the other hand, as described above, each of the plurality of frame units (the plurality of bipolar plates 410, the first end plate 431, the second end plate 432, and the plurality of (three in the present embodiment) spacers 420) has the joining surfaces 431a and 420a, 420a and 410a, 410a and 420a, 420a and 410a, 410a and 420a, and 420a and 432a facing each other in the stacking direction of the cell members 450, which are joined to each other by the joining material 440.

Specifically, the joining surface 431a formed on the other surface in the stacking direction of the first end plate 431 and the joining surface 420a formed on one surface in the stacking direction of the spacer 420, which are adjacent to each other in the stacking direction, are joined to each other by the joining material 440. The joining surface 410a formed on one surface in the stacking direction of all the bipolar plates 410 and the joining surface 420a formed on the other surface in the stacking direction of all the spacers 420, which are adjacent to each other in the stacking direction, are also joined to each other by the joining material 440. The joining surface 410a formed on the other surface in the stacking direction of all the bipolar plates 410 and the joining surface 420a formed on one surface in the stacking direction of all the spacers 420, which are adjacent to each other in the stacking direction, are also joined to each other by the joining material 440. Further, the joining surface 432a formed on one surface in the stacking direction of the second end plate 432 and the joining surface 420a formed on the other surface in the stacking direction of the spacer 420, which are adjacent to each other in the stacking direction, are also joined to each other by the joining material 440.

Therefore, the electrolyte in the cell C can be prevented from leaking out from between the joining surfaces 431a and 420a, 420a and 410a, 410a and 420a, 420a and 410a, 410a and 420a, and 420a and 432a by the joining material 440.

However, depending on a joining mode of the joining material 440 between the joining surfaces 431a and 420a, 420a and 410a, 410a and 420a, 420a and 410a, 410a and 420a, and 420a and 432a, the electrolyte may leak out.

Therefore, in the bipolar battery 400 according to the fourth embodiment, on the outer side surfaces 431b and 420b, 420b and 410b, 410b and 420b, 420b and 410b, 410b and 420b, and 420b and 432b of the frame units (the plurality of bipolar plates 410, the first end plate 431, the second end plate 432, and the plurality of spacers 420), which are adjacent to each other in the stacking direction, grooves 461 are formed which communicate between the joining surfaces 431a and 420a, 420a and 410a, 410a and 420a, 420a and 410a, 410a and 420a, and 420a and 432a, which are to be joined, and open to outer side surfaces 431b and 420b, 420b and 410b, 410b and 420b, 420b and 410b, 410b and 420b, and 420b and 432b). A water sealing material 462 is disposed in the grooves 461.

In other words, on the outer side surface 431b of the first end plate 431 and the outer side surface 420b of the spacer 420, which are adjacent to each other in the stacking direction, the outer side surfaces 420b of all the spacers 420 and the outer side surfaces 410b of all bipolar plates 410, which are adjacent to each other in the stacking direction, and the outer side surface 432b of the second end plate 432 and the outer side surface 420b of the spacer 420, which are adjacent to each other in the stacking direction, grooves 461 are formed that communicate the joining surfaces 431a and 420a, 420a and 410a, 410a and 420a, 420a and 410a, 410a and 420a, and 420a and 432a, which are to be joined, and open to outer side surfaces 431b and 420b, 420b and 410b, 410b and 420b, 420b and 410b, 410b and 420b, and 420b and 432b. The water sealing material 462 is disposed in the grooves 461.

Specifically, on the outer side surface 431b of the first end plate 431 and the outer side surface 420b of the spacer 420, which are adjacent to each other in the stacking direction, a groove 461 is formed that communicates the joining surface 431a formed on the other surface in the stacking direction of the first end plate 431 and the joining surface 420a formed on one surface in the stacking direction of the spacer 420, which are to be joined, and opens to the outer side surfaces 431b and 420b. The water sealing material 462 is disposed in the groove 461.

For each of the two bipolar plates 410, on the outer side surface 410b of the bipolar plate 410 and the outer side surface 420b of the spacer 420, which are adjacent to each other in the stacking direction, a groove 461 is formed that communicates the joining surface 410a formed on one surface in the stacking direction of the bipolar plate 410 and the joining surface 420a formed on the other surface in the stacking direction of the spacer 420, which are to be joined, and opens to the outer side surfaces 410b and 420b. The water sealing material 462 is disposed in the groove 461.

Further, for each of the two bipolar plates 410, on the outer side surface 410b of the bipolar plate 410 and the outer side surface 420b of the spacer 420, which are adjacent to each other in the stacking direction, a groove 461 is formed that communicates the joining surface 410a formed on the other surface in the stacking direction of the bipolar plate 410 and the joining surface 420a formed on one surface in the stacking direction of the spacer 420 and opens to the outer side surfaces 410b and 420b. The water sealing material 462 is disposed in the groove 461.

On the outer side surface 432b of the second end plate 432 and the outer side surface 420b of the spacer 420, which are adjacent to each other in the stacking direction, a groove 461 is formed that communicates the joining surface 432a formed on one surface in the stacking direction of the second end plate 432 and the joining surface 420a formed on the other surface in the stacking direction of the spacer 420, which are to be joined, and opens to the outer side surfaces 432b and 420b. The water sealing material 462 is disposed in the groove 461.

As described above, for the bipolar battery 400 according to the fourth embodiment, on the outer side surfaces 431b and 420b, 420b and 410b, 410b and 420b, 420b and 410b, 410b and 420b, and 420b and 432b of the frame units (the plurality of bipolar plates 410, the first end plate 431, the second end plate 432, and the plurality of spacers 420), which are adjacent to each other, grooves 461 are formed that communicate between the joining surfaces 431a and 420a, 420a and 410a, 410a and 420a, 420a and 410a, 410a and 420a, and 420a and 432a, which are to be joined, and open to the outer side surfaces 431b and 420b, 420b and 410b, 410b and 420b, 420b and 410b, 410b and 420b, and 420b and 432b. The water sealing material 462 is disposed in the grooves 461.

In other words, on the outer side surface 431b of the first end plate 431 and the outer side surface 420b of the spacer 420, which are adjacent to each other in the stacking direction, the outer side surfaces 420b of all spacers 420 and the outer side surfaces 410b of all bipolar plates 410, which are adjacent to each other in the stacking direction, the outer side surface 432b of the second end plate 432 and the outer side surface 420b of the spacer 420, which are adjacent to each other in the stacking direction, grooves 461 are formed that communicate with the joining surfaces 431a and 420a, 420a and 410a, 410a and 420a, 420a and 410a, 410a and 420a, and 420a and 432a, which are to be joined, and open to the outer side surfaces 431b and 420b, 420b and 410b, 410b and 420b, 420b and 410b, 410b and 420b, and 420b and 432b. The water sealing material 462 is disposed in the grooves 461.

Thus, even if the electrolyte leaking out of the cell C escapes the joining material 440 and leaks out from between the joining surfaces 431a and 420a, 420a and 410a, 410a and 420a, 420a and 410a, 410a and 420a, and 420a and 432a, the electrolyte can be reliably prevented from leaking out by the water sealing material 462.

In the bipolar battery 400 according to the fourth embodiment, the seal configuration may be formed simply by joining the above-described joining surfaces 431a and 420a, 420a and 410a, 410a and 420a, 420a and 410a, 410a and 420a, and 420a and 432a by the joining material 440, forming grooves 461 that communicate between the joining surfaces 431a and 420a, 420a and 410a, 410a and 420a, 420a and 410a, 410a and 420a, and 420a and 432a to be joined, and open to the outer side surfaces 431b and 420b, 420b and 410b, 410b and 420b, 420b and 410b, 410b and 420b, and 420b and 432b, and disposing the water sealing material 462 in the grooves 461, whereby the seal configuration can be simplified.

Therefore, for the bipolar battery 400 according to the fourth embodiment, it is possible to provide the bipolar battery 400 capable of reliably preventing the electrolyte from leaking out of the cell C by a simple seal configuration.

In the bipolar battery 400 according to the fourth embodiment, the plurality of frame units (a plurality of bipolar plates 410, the first end plate 431, the second end plate 432, and the plurality of spacers 420) includes the plurality of bipolar plates 410 disposed between the cell members 450 adjacent to each other in the stacking direction, the first end plate 431 disposed at one end and the second end plate 432 disposed at the other end in the stacking direction of the plurality of cell members 450, and the plurality of spacers 420 disposed between the bipolar plates 410 adjacent to each other in the stacking direction, between the first end plate 431 and the bipolar plate 410, and between the second end plate 432 and the bipolar plate 410. The plurality of cells C individually housing the plurality of cell members 450 is formed by the plurality of bipolar plates 410, the first end plate 431 and the second end plate 432, and the plurality of spacers 420. The joining surface 431a formed on the other surface in the stacking direction of the first end plate 431 and the joining surface 420a formed on the one surface in the stacking direction of the spacer 420, which are adjacent to each other in the stacking direction, the joining surface 410a formed on the one surface in the stacking direction of the bipolar plate 410 and the joining surface 420a formed on the other surface in the stacking direction of the spacer 420, which are adjacent to each other in the stacking direction, the joining surface 410a formed on the other surface in the stacking direction of the bipolar plate 410 and the joining surface 420a formed on the one surface in the stacking direction of the spacer 420, which are adjacent to each other in the stacking direction, and the joining surface 432a formed on the one surface in the stacking direction of the second end plate 432 and the joining surface 420a formed on the other surface in the stacking direction of the spacer 420, which are adjacent to each other in the stacking direction, are joined to each other by the joining material 440. The grooves 461 are formed on the outer side surface 431b of the first end plate 431 and the outer side surface 420b of the spacer 420, which are adjacent to each other in the stacking direction, the outer side surface 420b of the spacer 420 and the outer side surface 410b of the bipolar plate 410, which are adjacent to each other in the stacking direction, and the outer side surface 432b of the second end plate 432 and the outer side surface 420b of the spacer 420, which are adjacent to each other in the stacking direction. The water sealing material 462 is disposed in the grooves 461.

Thus, even if the electrolyte leaking from the cell C escapes the joining material 440 and leaks out from between the joining surfaces 431a and 420a, 420a and 410a, 410a and 420a, 420a and 410a, 410a and 420a, and 420a and 432a, the electrolyte can be reliably prevented from leaking out from the bipolar plate 410, the first end plate 431, the second end plate 432, and the spacer 420 by the water sealing material 462.

The seal configuration may be formed simply by joining the above-described joining surfaces 431a and 420a, 420a and 410a, 410a and 420a, 420a and 410a, 410a and 420a, and 420a and 432a by the joining material 440, forming grooves 461 that communicate between the joining surfaces 431a and 420a, 420a and 410a, 410a and 420a, 420a and 410a, 410a and 420a, and 420a and 432a to be joined, and open to the outer side surfaces 431b and 420b, 420b and 410b, 410b and 420b, 420b and 410b, 410b and 420b, and 420b and 432b of the bipolar plate 410 and other plates, and disposing the water sealing material 462 in the grooves 461. Thereby, the seal configuration can be simplified.

The shape of each groove 461 will now be described with reference to FIG. 11, and the shape of each water sealing material 462 will now be described with reference to FIGS. 11 and 12. FIG. 11 illustrates an enlarged view of a portion indicated by an arrow X in FIG. 10, and illustrates the vicinity of the joining surfaces 431a and 420a and the joining surfaces 420a and 410a. FIG. 12 illustrates a cross section of the water sealing material 462 used in the bipolar battery illustrated in FIG. 10.

Because the shapes of the groove 461 communicating between the joining surfaces 431a and 420a to be joined, the groove 461 communicating between the joining surfaces 420a and 410a to be joined, and the groove 461 communicating between the joining surfaces 420a and 432a to be joined, and the shape of the water sealing material 462 disposed in each of these grooves 461 are all the same, only the shape of the groove 461 communicating between the joining surfaces 420a and 410a to be joined and the shape of the water sealing material 462 disposed in the groove 461 will be described. The description of the shapes of the other grooves 461 and the water sealing material 462 will be omitted.

The cross-sectional shape of each groove 461 communicating between the joining surfaces 420a and 410a to be joined has a rectangular shape having a height W1 in the stacking direction (the vertical direction in FIG. 11) and a depth D1 in the direction orthogonal to the stacking direction (the horizontal direction in FIG. 11). Each groove 461 opens to the outer side surface 420b of the spacer 420 and the outer side surface 410b of the bipolar plate 410. Each groove 461 is continuously formed in an endless shape over the entire circumference of the quadrangular frame-shaped spacer 420 and the quadrangular shaped bipolar plate 410.

As illustrated in FIGS. 11 and 12, the water sealing material 462 disposed in the groove 461 communicating between the joining surfaces 420a and 410a to be joined has a quadrangular frame shape having a shape complementary to that of the groove 461. In the cross-sectional shape of the water sealing material 462, the height H1 in the stacking direction has the same dimension as the height W1 in the stacking direction of the groove 461, and the thickness t1 in the direction orthogonal to the stacking direction has the same dimension as the depth D1 of the groove 461.

On the spacer 420 side, the creepage distance in the groove 461 in contact with the water sealing material 462 (the distance from when the electrolyte passes between the joining surfaces 420a and 410a to when the electrolyte passes through the spacer 420 and the bipolar plate 410) is the sum of a stacking direction distance Wa1 in the groove 461 in contact with the water sealing material 462 and the distance in the direction orthogonal to the stacking direction in the groove 461 in contact with the water sealing material 462 (the distance equal to the thickness t1 of the water sealing material 462).

On the bipolar plate 410 side, the creepage distance in the groove 461 in contact with the water sealing material 462 is the sum of a stacking direction distance Wb1 in the groove 461 in contact with the water sealing material 462 and the distance in the direction orthogonal to the stacking direction in the groove 461 in contact with the water sealing material 462 (the distance equal to the thickness t1 of the water sealing material 462).

The longer the creepage distance in the groove 461 in contact with the water sealing material 462, the greater the water sealing effect (the effect of suppressing the electrolyte from leaking out) by the water sealing material 462.

To increase the creepage distance, it is necessary to increase the stacking direction distances Wa1 and Wb1 or the thickness t1 of the water sealing material 462. But, if the thickness t1 of the water sealing material 462 is increased, it is necessary to increase the depth D1 of the groove 461. If the depth D1 of the groove 461 is increased, the joining width B1 of the joining material 440 at the joining surfaces 420a and 410a is reduced, and thus the water sealing effect of the joining material 440 is reduced. On the other hand, if the joining width B1 of the joining material 440 at the joining surfaces 420a and 410a is maintained in a state in which the depth D1 of the groove 461 is increased, a width T1 of the spacer 420 is increased, and there is a problem in that the bipolar battery 400 is increased in size.

Therefore, to increase the creepage distance, it is preferable to increase the stacking direction distances Wa1 and Wb1. To increase the stacking direction distances Wa1 and Wb1, it is preferable that the height H1 in the stacking direction of the water sealing material 462 is increased larger than the thickness t1 in the direction orthogonal to the stacking direction of the water sealing material 462.

By increasing the height H1 in the stacking direction of the water sealing material 462 larger than the thickness t1 in the direction orthogonal to the stacking direction of the water sealing material 462 (H1>t1), it is possible to increase the creepage distance in the groove 461 in contact with the water sealing material 462 while maintaining the joining width B1 of the joining material 440 and the width T1 of the spacer 420 at the joining surfaces 420a and 410a, thereby improving the water sealing effect.

The material of the water sealing material 462 will now be described. The material of the water sealing material 462 is the same for all of the water sealing material 462 disposed in the groove 461 communicating between the joining surfaces 431a and 420a to be joined, the water sealing material 462 disposed in the groove 461 communicating between the joining surfaces 420a and 410a to be joined, and the water sealing material 462 disposed in the groove 461 communicating between the joining surfaces 420a and 432a to be joined.

Each water sealing material 462 is preferably any of dope cement, hot melt, a liquid gasket, or any combination thereof.

The dope cement is an adhesive obtained by dissolving a thermoplastic resin material in a solvent. When the dope cement is disposed in the groove 461, a liquid obtained by dissolving a thermoplastic resin material in a solvent may be poured into the groove 461 and dried to volatilize the solvent. Thus, the water sealing material 462 made of the dope cement is disposed in the groove 461 to be flush with the outer side surfaces 431b, 420b, 410b, and 432b of the first end plate 431, each of the spacers 420, each of the bipolar plates 410, and the second end plate 432.

The hot melt is an adhesive obtained by applying heat to a resin material to liquefy the resin material. When the hot melt is disposed in the groove 461, the resin material may be heated to be liquefied, and the liquefied resin material may be poured into the groove 461 and then cooled to be solidified. Thus, the water sealing material 462 made of the hot melt is disposed in the groove 461 to be flush with the outer side surfaces 431b, 420b, 410b, and 432b of the first end plate 431, each of the spacers 420, each of the bipolar plates 410, and the second end plate 432.

Further, the liquid gasket is an adhesive that maintains a liquid state at normal temperature and forms an elastic film or an adhesive thin film when dried after application. When the liquid gasket is disposed in the groove 461, the liquid gasket may be poured into the groove 461 and dried to solidify. Thus, the water sealing material 462 made of the liquid gasket is disposed in the groove 461 to be flush with the outer side surfaces 431b, 420b, 410b, and 432b of the first end plate 431, each of the spacers 420, each of the bipolar plates 410, and the second end plate 432.

As the resin material for the dope cement, ethylene-vinyl acetate copolymer (EVA) and acrylic resin are used in addition to the same resin as that of each frame unit. The resin material of the dope cement may be the same as or different from the material of the first end plate 431, the spacer 420, the bipolar plate 410, and the second end plate 432 having the grooves 461 in which the dope cement is disposed, but it is preferable if the resin material of the dope cement is the same as the material of the first end plate 431, the spacer 420, the bipolar plate 410, and the second end plate 432 having the grooves 461 in which the dope cement is disposed because the resin material of the dope cement easily conforms to the first end plate 431, the spacer 420, the bipolar plate 410, and the second end plate 432.

As the resin material for the hot melt, ethylene-vinyl acetate copolymer (EVA), acrylic resin, and synthetic rubber resin are used in addition to the same resin as that of each frame unit. The resin material of the hot melt may be the same as or different from the material of the first end plate 431, the spacer 420, the bipolar plate 410, and the second end plate 432 having the grooves 461 in which the hot melt is disposed, but it is preferable if the resin material of the hot melt is the same as the material of the first end plate 431, the spacer 420, the bipolar plate 410, and the second end plate 432 having the grooves 461 in which the hot melt is disposed because the resin material of the hot melt easily conforms to the first end plate 431, the spacer 420, the bipolar plate 410, and the second end plate 432.

Further, as the resin material for the liquid gasket, silicone resin, acrylic resin, and synthetic rubber resin are used in addition to the same resin as that of each frame unit. The resin material of the liquid gasket may also be the same as or different from the material of the first end plate 431, the spacer 420, the bipolar plate 410, and the second end plate 432 having the grooves 461 in which the liquid gasket is disposed, but it is preferable if the resin material of the liquid gasket is the same as the material of the first end plate 431, the spacer 420, the bipolar plate 410, and the second end plate 432 having the grooves 461 in which the liquid gasket is disposed because the resin material of the liquid gasket easily conforms to the first end plate 431, the spacer 420, the bipolar plate 410, and the second end plate 432.

As described above, for the bipolar battery 400 according to the fourth embodiment, because the water sealing material 462 is any of the dope cement, the hot melt, or the liquid gasket, the water sealing material 462 can be disposed in the groove 461 by a simple work process. The electrolyte can be reliably prevented from leaking out of the cell C.

### Fifth Embodiment

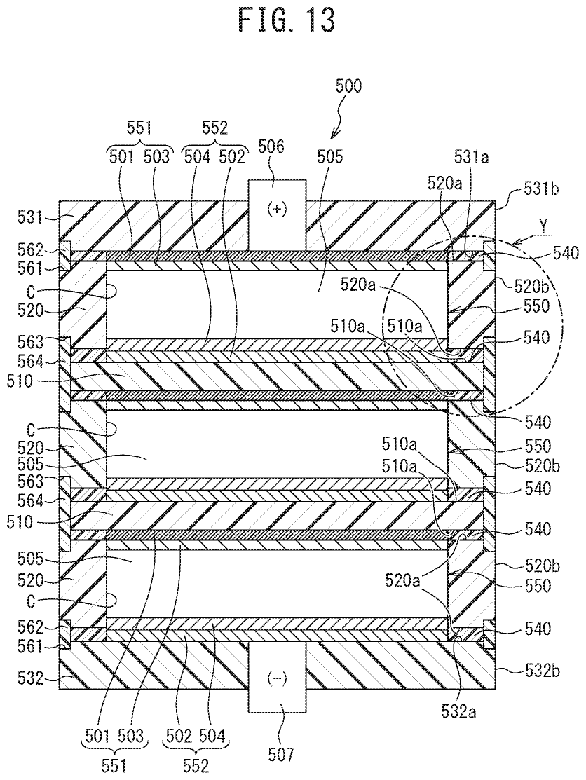

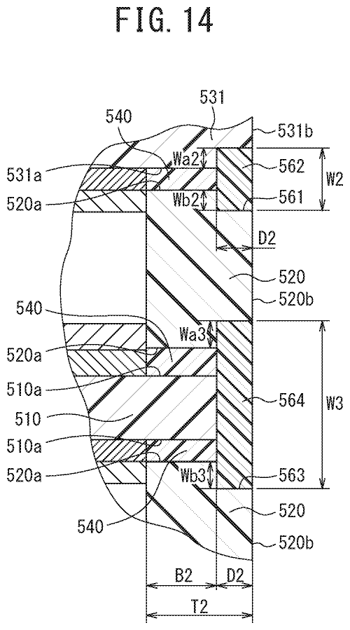

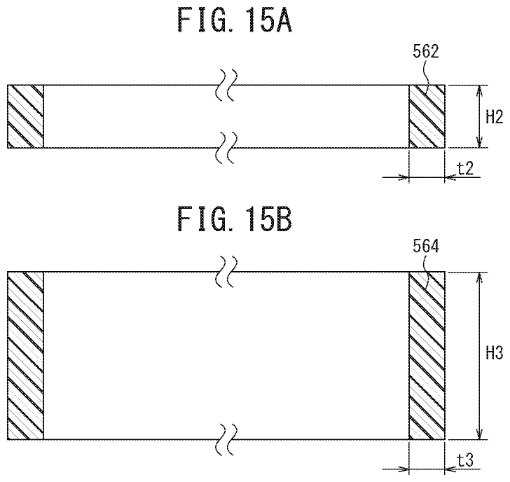

A bipolar battery according to a fifth embodiment of the present invention will now be described with reference to FIGS. 13 to 15B. FIG. 13 is a cross-sectional view illustrating a schematic configuration of a bipolar battery according to the fifth embodiment of the present invention. FIG. 14 is an enlarged view of a portion indicated by an arrow Yin FIG. 13. FIG. 15A is a cross-sectional view of the water sealing material used in the bipolar battery illustrated in FIG. 13 and FIG. 15B is a cross-sectional view of the common water sealing material used in the bipolar battery illustrated in FIG. 13.

A bipolar battery 500 according to the fifth embodiment of the present invention illustrated in FIG. 13 is a bipolar lead storage battery in which a positive electrode 551 has a positive electrode lead layer 501 and a negative electrode 552 has a negative electrode lead layer 502. The bipolar battery 500 includes a plurality of cell members 550, and a plurality of frame units (a plurality of bipolar plates 510, a first end plate 531, a second end plate 532, and a plurality of spacers 520) forming a plurality of cells C (also called spaces) individually housing the plurality of (three in the present embodiment) cell members 550. In the present embodiment, the bipolar battery 500 includes three cell members 550, and each frame unit includes two bipolar plates 510, the first end plate 531, the second end plate 532, and three spacers 520 forming three cells C individually housing the three cell members 550.

The plurality of cell members 550 is stacked at intervals in the stacking direction (the vertical direction in FIG. 13). As illustrated in FIG. 13, each cell member 550 includes a positive electrode 551 having a positive active material layer 503, a negative electrode 552 having a negative active material layer 504, and an electrolyte layer 505 interposed between the positive electrode 551 and the negative electrode 552.

The plurality of frame units includes the plurality of bipolar plates 510 disposed between the cell members 550 adjacent to each other in the stacking direction, the first end plate 531 disposed at one end (upper end in FIG. 13) in the stacking direction of the plurality of cell members 550, the second end plate 532 disposed at the other end (lower end in FIG. 13) in the stacking direction of the plurality of cell members 550, and the plurality of spacers 520 disposed between the bipolar plates 510 adjacent to each other in the stacking direction, between the first end plate 531 and the bipolar plate 510, and between the second end plate 532 and the bipolar plate 510.

The plurality of cells C individually housing the plurality of cell members 550 is formed by the plurality of bipolar plates 510, the first end plate 531 and the second end plate 532, and the plurality of spacers 520.

Each bipolar plate 510 has a quadrangular planar shape. Each bipolar plate 510 has a flat plate shape in which the negative electrode 552 is disposed on one surface (upper surface in FIG. 13) in the stacking direction and the positive electrode 551 is disposed on the other surface (lower surface in FIG. 13) in the stacking direction. Each bipolar plate 510 is disposed between the cell members 550 adjacent to each other in the stacking direction (the vertical direction in FIG. 13) of the cell members 550. Each bipolar plate 510 has a joining surface 510a formed on each of an outer circumference portion of the negative electrode 552 on one surface in the stacking direction and an outer circumference portion of the positive electrode 551 on the other surface in the stacking direction. The joining surface 510a on one surface side in the stacking direction of the bipolar plate 510 is in contact with the spacer 520 adjacent to each other at the one surface side in the stacking direction of the bipolar plate 510. The joining surface 510a on the other surface side in the stacking direction of the bipolar plate 510 is in contact with the spacer 520 adjacent to each other at the other surface side in the stacking direction of the bipolar plate 510. In other words, each bipolar plate 510 includes two joining surfaces 510a facing the two spacers 520 in the stacking direction of the cell members 550. The plate thickness of each bipolar plate 510 is set as appropriate but is less than the plate thickness of the bipolar plate 410 in the fourth embodiment illustrated in FIG. 10.

Each bipolar plate 510 is made of a thermoplastic resin having sulfuric acid resistance (e.g., polyethylene, polypropylene, polystyrene, polyvinyl chloride, polymethyl methacrylate (acrylic resin), acrylonitrile-butadiene-styrene copolymer (ABS), polyamide (nylon), or polycarbonate, or some combination thereof).

The first end plate 531 is disposed at one end (upper end in FIG. 13) in the stacking direction of the plurality of cell members 550 and has a flat plate shape having a quadrangular planar shape. The first end plate 531 is made of a thermoplastic resin having sulfuric acid resistance. The first end plate 531 has a plate thickness greater than the plate thickness of the bipolar plate 510.

The first end plate 531 covers the positive electrode 551 of the cell member 550 at one end side (upper end side in FIG. 13) in the stacking direction of the bipolar battery 500.

The first end plate 531 is disposed in parallel with the bipolar plate 510 and has a joining surface 531a formed at the outer circumference portion of the other surface (lower surface in FIG. 13) in the stacking direction of the first end plate. The joining surface 531a is in contact with the spacer 520 adjacent to each other at the other surface side in the stacking direction of the first end plate 531. In other words, the first end plate 531 includes the joining surface 531a facing the spacer 520 in the stacking direction of the cell members 550.

The second end plate 532 is disposed at the other end (lower end in FIG. 13) in the stacking direction of the plurality of cell members 550 and has a flat plate shape having a quadrangular planar shape. The second end plate 532 is made of a thermoplastic resin having sulfuric acid resistance. The second end plate 532 has a plate thickness greater than the plate thickness of a bipolar plate 510.

The second end plate 532 covers the negative electrode 552 of the cell member 550 at the other end side (lower end side in FIG. 13) in the stacking direction of the bipolar battery 500.

The second end plate 532 is disposed in parallel with the bipolar plate 510 and has a joining surface 532a formed at the outer circumference portion of one surface (upper surface in FIG. 13) in the stacking direction of the second end plate. The joining surface 532a is in contact with the spacer 520 adjacent to each other at one surface side in the stacking direction of the second end plate 532. In other words, the second end plate 532 includes the joining surface 532a facing the spacer 520 in the stacking direction of the cell members 550.

The spacers 520 are respectively disposed between the bipolar plates 510 adjacent to each other in the stacking direction, between the first end plate 531 and the bipolar plate 510, and between the second end plate 532 and the bipolar plate 510.

The spacer 520 disposed between the bipolar plates 510 adjacent to each other in the stacking direction is formed in a quadrangular frame shape to surround the side surface of the cell member 550. The spacer 520 is made of a thermoplastic resin having sulfuric acid resistance. The spacer 520 has a plate thickness greater than the plate thickness of the bipolar plate 510.

The spacer 520 is disposed in parallel with the bipolar plate 510 and has a joining surface 520a formed on one surface (upper surface in FIG. 13) in the stacking direction of the spacer. The joining surface 520a is in contact with the bipolar plate 510 adjacent to each other at one surface side in the stacking direction. The spacer 520 has a joining surface 520a also formed on the other surface (lower surface in FIG. 13) in the stacking direction of the spacer. The joining surface 520a is in contact with the bipolar plate 510 adjacent to each other at the other surface side in the stacking direction. In other words, the spacer 520 includes two joining surfaces 520a facing the two bipolar plates 510 in the stacking direction of the cell members 550.

The spacer 520 disposed between the first end plate 531 and the bipolar plate 510 is formed in a quadrangular frame shape to surround the side surface of the cell member 550. The spacer 520 is made of a thermoplastic resin having sulfuric acid resistance. The spacer 520 has a plate thickness greater than the plate thickness of the bipolar plate 510.

The spacer 520 is disposed in parallel with the bipolar plate 510 and has a joining surface 520a formed on one surface (upper surface in FIG. 13) in the stacking direction. The joining surface 520a is in contact with the first end plate 531 adjacent to each other at one surface side in the stacking direction. The spacer 520 has a joining surface 520a also formed on the other surface (lower surface in FIG. 13) in the stacking direction of the spacer. The joining surface 520a is in contact with the bipolar plate 510 adjacent to each other at the other surface side in the stacking direction. In other words, the spacer 520 includes two joining surfaces 520a facing the first end plate 531 and the bipolar plate 510 in the stacking direction (the vertical direction in FIG. 13) of the cell members 550.

Further, the spacer 520 disposed between the second end plate 532 and the bipolar plate 510 is formed in a quadrangular frame shape to surround the side surface of the cell member 550. The spacer 520 is made of a thermoplastic resin having sulfuric acid resistance. The spacer 520 has a plate thickness greater than the plate thickness of the bipolar plate 510.

The spacer 520 is disposed in parallel to the bipolar plate 510 and has a joining surface 520a formed on one surface (upper surface in FIG. 13) in the stacking direction. The joining surface 520a is in contact with the bipolar plate 510 adjacent to each other at one side in the stacking direction. The spacer 520 has a joining surface 520a also formed on the other surface (lower surface in FIG. 13) in the stacking direction. The joining surface 520a is in contact with the second end plate 532 adjacent to each other at the other side in the stacking direction. In other words, the spacer 520 includes two joining surfaces 520a facing the bipolar plate 510 and the second end plate 532 in the stacking direction (the vertical direction in FIG. 13) of the cell members 550.

A negative electrode lead layer 502 is disposed on one surface in the stacking direction of the bipolar plate 510. A positive electrode lead layer 501 is disposed on the other surface in the stacking direction of the bipolar plate 510. A negative active material layer 504 is disposed on the negative electrode lead layer 502 to form a negative electrode 552. A positive active material layer 503 is disposed on the positive electrode lead layer 501 to form a positive electrode 551.

Between the positive active material layer 503 and the negative active material layer 504 facing each other, an electrolyte layer 505 is disposed that is made of a glass fiber mat or the like impregnated with an electrolyte such as sulfuric acid.

A positive electrode lead layer 501 is disposed on the other surface in the stacking direction of the first end plate 531. A positive active material layer 503 is disposed on the positive electrode lead layer 501 on the first end plate 531 to form a positive electrode 551. Between the positive active material layer 503 on the first end plate 531 and the negative active material layer 504 of the bipolar plate 510 facing the positive active material layer, an electrolyte layer 505 is disposed which is made of a glass fiber mat or the like impregnated with an electrolyte such as sulfuric acid.

A negative electrode lead layer 502 is disposed on one surface in the stacking direction of the second end plate 532. A negative active material layer 504 is disposed on the negative electrode lead layer 502 on the second end plate 532 to form a negative electrode 552. Between the negative active material layer 504 on the second end plate 532 and the positive active material layer 503 of the bipolar plate 510 facing the negative active material layer, an electrolyte layer 505 is disposed which is made of a glass fiber mat or the like impregnated with an electrolyte such as sulfuric acid.

The positive electrode lead layer 501 on the first end plate 531 is provided with a positive electrode terminal 506 electrically conductive to the outside of the first end plate 531. The negative electrode lead layer 502 on the second end plate 532 is provided with a negative electrode terminal 507 electrically conductive to the outside of the second end plate 532.

In other words, the bipolar battery 500 according to the fifth embodiment includes the plurality of cell members 550 each including the positive electrode 551 having the positive active material layer 503, the negative electrode 552 having the negative active material layer 504, and the electrolyte layer 505 interposed between the positive electrode 551 and the negative electrode 552, and the plurality of frame units (the plurality of bipolar plates 510, the first end plate 531, the second end plate 532, and the plurality of spacers 520) forming the plurality of cells C (also called spaces) individually housing the plurality of cell members 550.

The plurality of frame units includes the plurality of bipolar plates 510 disposed between the cell members 550 adjacent to each other in the stacking direction, the first end plate 531 disposed at one end (upper end in FIG. 13) in the stacking direction of the plurality of cell members 550, the second end plate 532 disposed at the other end (lower end in FIG. 13) in the stacking direction of the plurality of cell members 550, and the plurality of spacers 520 disposed between the bipolar plates 510 adjacent to each other in the stacking direction, between the first end plate 531 and the bipolar plate 510, and between the second end plate 532 and the bipolar plate 510.

The plurality of cells C individually housing the plurality of cell members 550 is formed by the plurality of bipolar plates 510, the first end plate 531 and the second end plate 532, and the plurality of spacers 520.

The cell members 550 adjacent to each other in the stacking direction are electrically connected to each other in series. Therefore, the bipolar plate 510 interposed between the cell members 550 adjacent to each other in the stacking direction includes a means for electrically connecting the positive electrode lead layer 501 and the negative electrode lead layer 502.

Each of the plurality of frame units (the plurality of bipolar plates 510, the first end plate 531, the second end plate 532, and the plurality of spacers 520) has joining surfaces 531a and 520a, 520a and 510a, 510a and 520a, 520a and 510a, 510a and 520a, and 520a and 532a facing each other in the stacking direction of the cell members 550, which are joined to each other by a joining material 540 (see FIG. 14).

Specifically, the joining surface 531a formed on the other surface in the stacking direction of the first end plate 531 and the joining surface 520a formed on one surface in the stacking direction of the spacer 520, which are adjacent to each other in the stacking direction, are joined to each other by the joining material 540. The joining surface 510a formed on one surface in the stacking direction of all the bipolar plates 510 and the joining surface 520a formed on the other surface in the stacking direction of all the spacers 520, which are adjacent to each other in the stacking direction, are also joined to each other by the joining material 540. The joining surface 510a formed on the other surface in the stacking direction of all the bipolar plates 510 and the joining surface 520a formed on one surface in the stacking direction of all the spacers 520, which are adjacent to each other in the stacking direction, are also joined to each other by the joining material 540. Further, the joining surface 532a formed on one surface in the stacking direction of the second end plate 532 and the joining surface 520a formed on the other surface in the stacking direction of the spacer 520, which are adjacent to each other in the stacking direction, are also joined to each other by the joining material 540.

The joining material 540 is an adhesive or a fusing material.

The fusing material is a fusing material generated by vibration welding. For example, when the joining surface 531a formed on the other surface in the stacking direction of the first end plate 531 and the joining surface 520a formed on one surface in the stacking direction of the spacer 520 are joined to each other, one joining surface 531a is pressed against the other joining surface 520a and vibrated to generate frictional heat, the one joining surface 531a and the other joining surface 520a are melted to generate melt, thereby forming a fusing material.

In the bipolar battery 500 configured as described above, the electrolyte layer 505 constituting the cell member 550 in the cell C is impregnated with an electrolyte.

On the other hand, as described above, each of the plurality of frame units (the plurality of bipolar plates 510, the first end plate 531, the second end plate 532, and the plurality of spacers 520) has the joining surfaces 531a and 520a, 520a and 510a, 510a and 520a, 520a and 510a, 510a and 520a, and 520a and 532a facing each other in the stacking direction of the cell members 550, which are joined to each other by the joining material 540.

Specifically, the joining surface 531a formed on the other surface in the stacking direction of the first end plate 531 and the joining surface 520a formed on one surface in the stacking direction of the spacer 520, which are adjacent to each other in the stacking direction, are joined to each other by the joining material 540. The joining surface 510a formed on one surface in the stacking direction of all the bipolar plates 510 and the joining surface 520a formed on the other surface in the stacking direction of all the spacers 520, which are adjacent to each other in the stacking direction, are also joined to each other by the joining material 540. The joining surface 510a formed on the other surface in the stacking direction of all the bipolar plates 510 and the joining surface 520a formed on one surface in the stacking direction of all the spacers 520, which are adjacent to each other in the stacking direction, are also joined to each other by the joining material 540. Further, the joining surface 532a formed on one surface in the stacking direction of the second end plate 532 and the joining surface 520a formed on the other surface in the stacking direction of the spacer 520, which are adjacent to each other in the stacking direction, are also joined to each other by the joining material 540.

Therefore, the electrolyte in the cell C can be prevented from leaking out from between the joining surfaces 531a and 520a, 520a and 510a, 510a and 520a, 520a and 510a, 510a and 520a, and 520a and 532a by the joining material 540.

However, depending on a joining mode of the joining material 540 between the joining surfaces 531a and 520a, 520a and 510a, 510a and 520a, 520a and 510a, 510a and 520a, and 520a and 532a, the electrolyte may leak out.

Therefore, in the bipolar battery 500 according to the fifth embodiment, on the outer side surfaces 531b and 520b, and 520b and 532b of the frame units, which are adjacent to each other in the stacking direction, grooves 561 are formed that communicate between the joining surfaces 531a and 520a, and 520a and 532a, which are to be joined, and open to outer side surfaces 531b and 520b, and 520b and 532b. A water sealing material 562 is disposed in the grooves 561.

Specifically, in the bipolar battery 500 according to the fifth embodiment, as in the bipolar battery 400 according to the fourth embodiment, on the outer side surface 531b of the first end plate 531 and the outer side surface 520b of the spacer 520, which are adjacent to each other in the stacking direction, a groove 561 is formed which communicates between the joining surface 531a formed on the other surface in the stacking direction of the first end plate 531 and the joining surface 520a formed on one surface in the stacking direction of the spacer 520, which are to be joined, and opens to the outer side surfaces 531b and 520b. A water sealing material 562 is disposed in the groove 561.

In the bipolar battery 500 according to the fifth embodiment, as in the bipolar battery 400 according to the fourth embodiment, on the outer side surface 532b of the second end plate 532 and the outer side surface 520b of the spacer 520, which are adjacent to each other in the stacking direction, a groove 561 is formed which communicates between the joining surface 532a formed on one surface in the stacking direction of the second end plate 532 and the joining surface 520a formed on the other surface in the stacking direction of the spacer 520, which are to be joined, and opens to the outer side surfaces 532b and 520b. The water sealing material 562 is disposed in the groove 561.

In the bipolar battery 500 according to the fifth embodiment, for all (two in the present embodiment) the bipolar plates 510, on the outer side surface of the bipolar plate 510 and the outer side surface 520b of the spacer 520, which are adjacent to each other in the stacking direction, a groove similar to the groove 561 is formed that communicates between the joining surface 510a formed on one surface in the stacking direction of the bipolar plate 510 and the joining surface 520a formed on the other surface in the stacking direction of the spacer 520, which are to be joined.

In the bipolar battery 500 according to the fifth embodiment, for all the bipolar plates 510, on the outer side surface of the bipolar plate 510 and the outer side surface 520b of the spacer 520, which are adjacent to each other in the stacking direction, a groove similar to the groove 561 is formed that communicates between the joining surface 510a formed on the other surface in the stacking direction of the bipolar plate 510 and the joining surface 520a formed on one surface in the stacking direction of the spacer 520, which are to be joined.

However, the bipolar battery 500 according to the fifth embodiment is different from the bipolar battery 400 according to the fourth embodiment. As illustrated in FIG. 13, for all the bipolar plates 510, the groove communicating between the joining surface 510a formed on one surface in the stacking direction of the bipolar plate 510 and the joining surface 520a formed on the other surface in the stacking direction of the spacer 520 and the groove communicating between the joining surface 510a formed on the other surface in the stacking direction of the bipolar plate 510 and the joining surface 520a formed on one surface in the stacking direction of the spacer 520 are an identical common groove 563 communicating with each other. A common water sealing material 564 is disposed in the common groove 563 instead of the water sealing material 562.

As described above, for the bipolar battery 500 according to the fifth embodiment, on the outer side surface 531b of the first end plate 531 and the outer side surface 520b of the spacer 520, which are adjacent to each other in the stacking direction, a groove 561 is formed that communicates between the joining surface 531a formed on the other surface in the stacking direction of the first end plate 531 and the joining surface 520a formed on one surface in the stacking direction of the spacer 520, which are to be joined, and opens to outer side surfaces 531b and 520b. The water sealing material 562 is disposed in the groove 561.

For the bipolar battery 500 according to the fifth embodiment, on the outer side surface 532b of the second end plate 532 and the outer side surface 520b of the spacer 520, which are adjacent to each other in the stacking direction, a groove 561 is formed that communicates between the joining surface 532a formed on one surface in the stacking direction of the second end plate 532 and the joining surface 520a formed on the other surface in the stacking direction of the spacer 520, which are to be joined, and opens to the outer side surfaces 532b and 520b. The water sealing material 562 is disposed in the groove 561.

Further, for the bipolar battery 500 according to the fifth embodiment, for all the bipolar plates 510, the groove communicating between the joining surface 510a formed on one surface in the stacking direction of the bipolar plate 510 and the joining surface 520a formed on the other surface in the stacking direction of the spacer 520 and the groove communicating between the joining surface 510a formed on the other surface in the stacking direction of the bipolar plate 510 and the joining surface 520a formed on one surface in the stacking direction of the spacer 520 are an identical common groove 563 communicating with each other. The common water sealing material 564 is disposed in the common groove 563 instead of the water sealing material 562.

Thus, even if the electrolyte leaking out of the cell C escapes the joining material 540 and leaks out from between the joining surfaces 531a and 520a, 520a and 510a, 510a and 520a, 520a and 510a, 510a and 520a, and 520a and 532a, the electrolyte can be reliably prevented from leaking out by the water sealing material 562 and the common water sealing material 564.

For the bipolar battery 500 according to the fifth embodiment, for all the bipolar plates 510, the groove communicating between the joining surface 510a formed on one surface in the stacking direction of the bipolar plate 510 and the joining surface 520a formed on the other surface in the stacking direction of the spacer 520 and the groove communicating between the joining surface 510a formed on the other surface in the stacking direction of the bipolar plate 510 and the joining surface 520a formed on one surface in the stacking direction of the spacer 520 are an identical common groove 563 communicating with each other. The common water sealing material 564 is disposed in the common groove 563 instead of the water sealing material 562. Thus, a groove on one surface side in the stacking direction and a groove on the other surface side in the stacking direction of each bipolar plate 510 may be formed by one common groove 563, so that groove machining can be easily performed. One common water sealing material 564 may be disposed in the common groove 563, so that there is an advantage in that the number of components can be reduced compared to the bipolar battery 400 according to the fourth embodiment.

Because it is not necessary to form two grooves in each bipolar plate 510, the plate thickness of the bipolar plate 510 can be reduced, and the weight of the bipolar battery 500 can be reduced compared to the bipolar battery 400 according to the fourth embodiment.

The shape of each groove 561 and the shape of each common groove 563 will now be described with reference to FIG. 14. The shape of each water sealing material 562 and the shape of each common water sealing material 564 will now be described with reference to FIGS. 14, 15A, and 15B. FIG. 14 illustrates an enlarged state of a portion indicated by an arrow Y in FIG. 13. FIG. 15A is a cross-sectional view of the water sealing material used in the bipolar battery illustrated in FIG. 13 and FIG. 15B is a cross-sectional view of the common water sealing material used in the bipolar battery illustrated in FIG. 13.

Because the shapes of the groove 561 communicating between the joining surfaces 531a and 520a to be joined and the groove 561 communicating between the joining surfaces 520a and 532a to be joined, and the shape of the water sealing material 562 disposed in these grooves 561 are identical, only the shape of the groove 561 communicating between the joining surfaces 531a and 520a to be joined and the shape of the water sealing material 562 disposed in the groove 561 will be described. The description of the shapes of the other grooves 561 and water sealing material 562 will be omitted.

The cross-sectional shape of the groove 561 communicating between the joining surfaces 531a and 520a to be joined has a rectangular shape having a height W2 in the stacking direction (the vertical direction in FIG. 14) and a depth D2 in the direction orthogonal to the stacking direction (the horizontal direction in FIG. 14). The groove 561 opens to the outer side surface 531b of the first end plate 531 and the outer side surface 520b of the spacer 520. The groove 561 is continuously formed in an endless shape over the entire circumference of the quadrangular shaped first end plate 531 and the quadrangular frame-shaped spacer 520.

As illustrated in FIGS. 14 and 15A, the water sealing material 562 disposed in the groove 561 communicating between the joining surfaces 531a and 520a to be joined has a quadrangular frame shape having a shape complementary to that of the groove 561. In the cross-sectional shape of the water sealing material 562, the height H2 in the stacking direction has the same dimension as the height W2 in the stacking direction of the groove 561, and the thickness t2 in the direction orthogonal to the stacking direction has the same dimension as the depth D2 of the groove 561.

On the first end plate 531 side, the creepage distance in the groove 561 in contact with the water sealing material 562 is the sum of a stacking direction distance Wa2 in the groove 561 in contact with the water sealing material 562 and the distance in the direction orthogonal to the stacking direction in the groove 561 in contact with the water sealing material 562 (the distance equal to the thickness t2 of the water sealing material 562).

On the spacer 520 side, the creepage distance in the groove 561 in contact with the water sealing material 562 is the sum of a stacking direction distance Wb2 in the groove 561 in contact with the water sealing material 562 and the distance in the direction orthogonal to the stacking direction in the groove 561 in contact with the water sealing material 562 (the distance equal to the thickness t2 of the water sealing material 562).

The longer the creepage distance in the groove 561 is in contact with the water sealing material 562, the greater the water sealing effect (the effect of suppressing the electrolyte from leaking out) by the water sealing material 562.

To increase the creepage distance, it is necessary to increase the stacking direction distances Wa2 and Wb2 or the thickness t2 of the water sealing material 562, but if the thickness t2 of the water sealing material 562 is increased, it is necessary to increase the depth D2 of the groove 561. If the depth D2 of the groove 561 is increased, the joining width B2 of the joining material 540 at the joining surfaces 531a and 520a is reduced, and thus the water sealing effect of the joining material 540 is reduced. On the other hand, if the joining width B2 of the joining material 540 at the joining surfaces 531a and 520a is maintained in a state in which the depth D2 of the groove 561 is increased, a width T2 of the spacer 520 is increased, and there is a problem in that the bipolar battery 500 is increased in size.

Therefore, to increase the creepage distance, it is preferable to increase the stacking direction distances Wa2 and Wb2. To increase the stacking direction distances Wa2 and Wb2, it is preferable that the height H2 in the stacking direction of the water sealing material 562 is increased larger than the thickness t2 in the direction orthogonal to the stacking direction of the water sealing material 562.

By increasing the height H2 in the stacking direction of the water sealing material 562 larger than the thickness t2 in the direction orthogonal to the stacking direction of the water sealing material 562 (H2>t2), it is possible to increase the creepage distance in the groove 561 in contact with the water sealing material 562 while maintaining the joining width B2 of the joining material 540 and the width T2 of the spacer 520 at the joining surfaces 531a and 520a, thereby improving the water sealing effect. The same applies to the water sealing material 562 disposed in the groove 561 communicating the joining surfaces 532a and 520a.

The shape of the common groove 563 will now be described. As illustrated in FIG. 14, the cross-sectional shape of the identical common groove 563 in which the groove communicating between the joining surface 510a formed on one surface in the stacking direction of the bipolar plate 510 and the joining surface 520a formed on the other surface in the stacking direction of the spacer 520 and the groove communicating between the joining surface 510a formed on the other surface in the stacking direction of the bipolar plate 510 and the joining surface 520a formed on one surface in the stacking direction of the spacer 520 communicate with each other. The common groove 563 has a rectangular shape having a height W3 in the stacking direction (the vertical direction in FIG. 14) and the depth D2 in the direction orthogonal to the stacking direction (the horizontal direction in FIG. 14). The common groove 563 opens over the outer side surface 520b of the spacer 520 on one surface side in the stacking direction of the bipolar plate 510, the outer side surface of the bipolar plate 510, and the outer side surface 520b of the spacer 520 on the other surface side in the stacking direction of the bipolar plate 510. The common groove 563 is continuously formed in an endless shape over the entire circumference of the two quadrangular frame-shaped spacers 520 and the quadrangular shaped bipolar plate 510.

As illustrated in FIGS. 14 and 15B, the common water sealing material 564 disposed in the common groove 563 has a quadrangular frame shape having a shape complementary to that of the common groove 563. In the cross-sectional shape of the common water sealing material 564, the height H3 in the stacking direction has the same dimension as the height W3 in the stacking direction of the common groove 563, and a thickness t3 in the direction orthogonal to the stacking direction has the same dimension as the depth D2 of the common groove 563.

On the spacer 520 side on one surface side in the stacking direction, the creepage distance in a common groove 563 in contact with the common water sealing material 564 is the sum of a stacking direction distance Wa3 in the common groove 563 in contact with the common water sealing material 564 and the distance in the direction orthogonal to the stacking direction (the distance equal to the thickness t3 of the common water sealing material 564) in the common groove 563 in contact with the common water sealing material 564.

On the spacer 520 side on the other surface side in the stacking direction, the creepage distance in the common groove 563 in contact with the common water sealing material 564 is the sum of a stacking direction distance Wb3 in the common groove 563 in contact with the common water sealing material 564 and the distance in the direction orthogonal to the stacking direction (the distance equal to the thickness t3 of the common water sealing material 564) in the common groove 563 in contact with the common water sealing material 564.

The longer the creepage distance in the common groove 563 is in contact with the common water sealing material 564, the greater the water sealing effect (the effect of suppressing the electrolyte from leaking out) by the common water sealing material 564.

To increase the creepage distance, it is necessary to increase the stacking direction distances Wa3 and Wb3 or the thickness t3 of the common water sealing material 564. But, if the thickness t3 of the common water sealing material 564 is increased, it is necessary to increase the depth D2 of the common groove 563. If the depth D2 of the common groove 563 is increased, the joining width B2 of the joining material 540 is reduced, and thus the water sealing effect of the joining material 540 is reduced. On the other hand, if the joining width B2 of the joining material 540 is maintained in a state in which the depth D2 of the common groove 563 is increased, the width T2 of the spacer 520 is increased, and there is a problem in that the bipolar battery 500 is increased in size.

Therefore, to increase the creepage distance, it is preferable to increase the stacking direction distances Wa3 and Wb3. To increase the stacking direction distances Wa3 and Wb3, it is preferable that the height H3 in the stacking direction of the common water sealing material 564 is increased larger than the thickness t3 in the direction orthogonal to the stacking direction of the common water sealing material 564.

By increasing the height H3 in the stacking direction of the common water sealing material 564 larger than the thickness t3 in the direction orthogonal to the stacking direction of the common water sealing material 564 (H3>t3), it is possible to increase the creepage distance in the common groove 563 in contact with the common water sealing material 564 while maintaining the joining width B2 of the joining material 540 and the width T2 of the spacer 520, thereby improving the water sealing effect.

As with the water sealing material 462, the material of the water sealing material 562 is preferably any of dope cement, hot melt, or a liquid gasket, or any combination thereof. Thus, for the bipolar battery 500 according to the fifth embodiment, because the water sealing material 562 is any of the dope cement, the hot melt, or the liquid gasket, the water sealing material 562 can be disposed in the groove 561 by a simple work process. The electrolyte can be reliably prevented from leaking out of the cell C.

The material of the common water sealing material 564 is also the same as that of the water sealing material 562, and is preferably any of dope cement, hot melt, or a liquid gasket.

When the dope cement is disposed in the common groove 563, a liquid obtained by dissolving a thermoplastic resin material in a solvent may be poured into the common groove 563 and dried to volatilize the solvent. Thus, the common water sealing material 564 made of the dope cement is disposed in the common groove 563 to be flush with the outer side surfaces 520b of the two spacers 520.

When the hot melt is disposed in the common groove 563, the resin material may be heated to be liquefied, and the liquefied resin material may be poured into the common groove 563 and then cooled to be solidified. Thus, the common water sealing material 564 made of the hot melt is disposed in the common groove 563 to be flush with the outer side surfaces 520b of the two spacers 520.

Further, the liquid gasket is an adhesive that maintains a liquid state at normal temperature and forms an elastic film or an adhesive thin film when dried after application. When the liquid gasket is disposed in the common groove 563, the liquid gasket may be poured into the common groove 563 and dried to solidify. Thus, the common water sealing material 564 made of the liquid gasket is disposed in the common groove 563 to be flush with the outer side surfaces 520b of the two spacers 520.

Thus, for the bipolar battery 500 according to the fifth embodiment, because the common water sealing material 564 is any of the dope cement, the hot melt, or the liquid gasket, the common water sealing material 564 can be disposed in the common groove 563 by a simple work process. The electrolyte can be reliably prevented from leaking out of the cell C.

### Sixth Embodiment

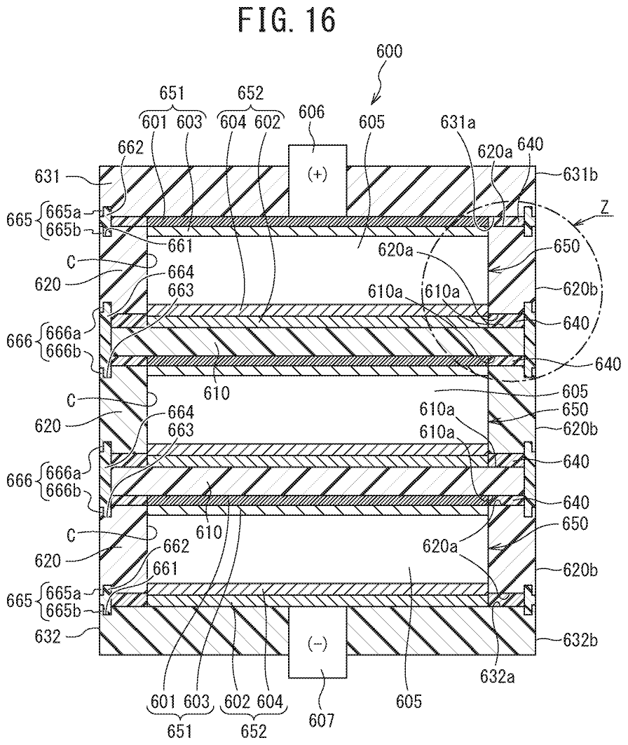

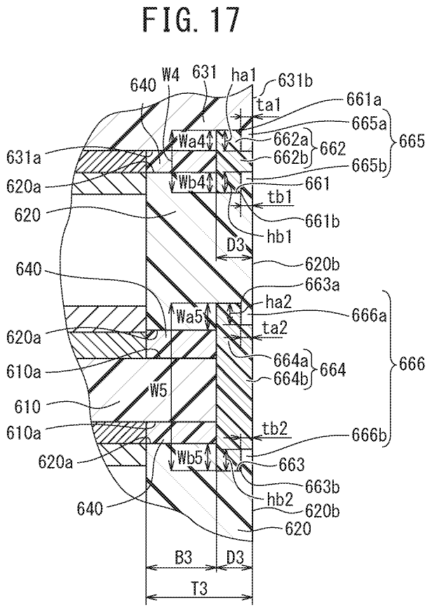

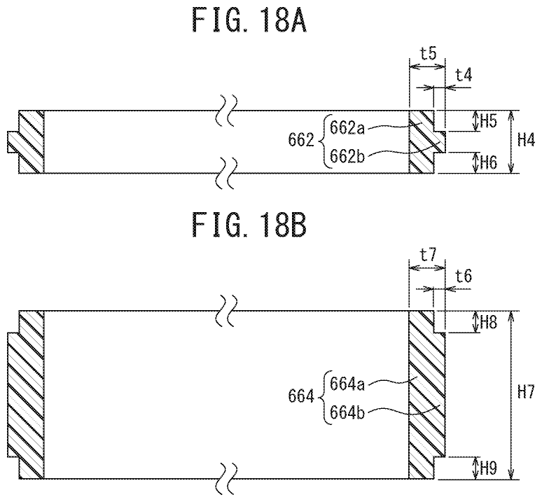

A bipolar battery according to a sixth embodiment of the present invention will now be described with reference to FIGS. 16 to 18B. FIG. 16 is a cross-sectional view illustrating a schematic configuration of a bipolar battery according to the sixth embodiment of the present invention. FIG. 17 is an enlarged view of a portion indicated by an arrow Z in FIG. 16. FIG. 18A is a cross-sectional view of the water sealing material used in the bipolar battery illustrated in FIG. 16 and FIG. 18B is a cross-sectional view of the common water sealing material used in the bipolar battery illustrated in FIG. 16.

A bipolar battery 600 according to the sixth embodiment of the present invention illustrated in FIG. 16 is a bipolar lead storage battery in which a positive electrode 651 has a positive electrode lead layer 601 and a negative electrode 652 has a negative electrode lead layer 602. The bipolar battery 600 also includes a plurality of cell members 650 and a plurality of frame units (a plurality of bipolar plates 610, a first end plate 631, a second end plate 632, and a plurality of spacers 620) forming a plurality of cells C (also called spaces) individually housing the plurality of cell members 650. In the present embodiment, the bipolar battery 600 includes three cell members 650, and frame unit includes two bipolar plates 610, the first end plate 631, the second end plate 632, and three spacers 620 forming three cells C individually housing three cell members 650.

The plurality of cell members 650 is stacked at intervals in the stacking direction (the vertical direction in FIG. 16). As illustrated in FIG. 16, each cell member 650 includes a positive electrode 651 having a positive active material layer 603, a negative electrode 652 having a negative active material layer 604, and an electrolyte layer 605 interposed between the positive electrode 651 and the negative electrode 652.

The plurality of frame units includes the plurality of bipolar plates 610 disposed between the cell members 650 adjacent to each other in the stacking direction, the first end plate 631 disposed at one end (upper end in FIG. 16) in the stacking direction of the plurality of cell members 650, the second end plate 632 disposed at the other end (lower end in FIG. 16) in the stacking direction of the plurality of cell members 650, and the plurality of spacers 620 disposed between the bipolar plates 610 adjacent to each other in the stacking direction, between the first end plate 631 and the bipolar plate 610, and between the second end plate 632 and the bipolar plate 610.

The plurality of cells C individually housing the plurality of cell members 650 is formed by the plurality of bipolar plates 610, the first end plate 631 and the second end plate 632, and the plurality of spacers 620.

Each bipolar plate 610 has a quadrangular planar shape. Each bipolar plate 610 has a flat plate shape in which the negative electrode 652 is disposed on one surface (upper surface in FIG. 16) in the stacking direction and the positive electrode 651 is disposed on the other surface (lower surface in FIG. 16) in the stacking direction. Each bipolar plate 610 is disposed between the cell members 650 adjacent to each other in the stacking direction (the vertical direction in FIG. 16) of the cell members 650. Each bipolar plate 610 has a joining surface 610a formed on each of an outer circumference portion of the negative electrode 652 on one surface in the stacking direction and an outer circumference portion of the positive electrode 651 on the other surface in the stacking direction. The joining surface 610a on one surface side in the stacking direction of the bipolar plate 610 is in contact with the spacer 620 adjacent to each other at the one surface side in the stacking direction of the bipolar plate 610. The joining surface 610a on the other surface side in the stacking direction of the bipolar plate 610 is in contact with the spacer 620 adjacent to each other at the other surface side in the stacking direction of the bipolar plate 610. In other words, each bipolar plate 610 includes two joining surfaces 610a facing the two spacers 620 in the stacking direction of the cell members 650. The plate thickness of each bipolar plate 610 is set as appropriate but is the same as the plate thickness of the bipolar plate 510 in the fifth embodiment illustrated in FIG. 13 and is less than the plate thickness of the bipolar plate 410 in the fourth embodiment illustrated in FIG. 10.

Each bipolar plate 610 is made of a thermoplastic resin having sulfuric acid resistance (e.g., polyethylene, polypropylene, polystyrene, polyvinyl chloride, polymethyl methacrylate (acrylic resin), acrylonitrile-butadiene-styrene copolymer (ABS), polyamide (nylon), or polycarbonate, or some combination thereof).

The first end plate 631 is disposed at one end (upper end in FIG. 16) in the stacking direction of the plurality of cell members 650 and has a flat plate shape having a quadrangular planar shape. The first end plate 631 is made of a thermoplastic resin having sulfuric acid resistance. The first end plate 631 has a plate thickness greater than the plate thickness of the bipolar plate 610.

The first end plate 631 covers the positive electrode 651 of the cell member 650 at one end side (upper end side in FIG. 16) in the stacking direction of the bipolar battery 600.

The first end plate 631 is disposed in parallel with the bipolar plate 610 and has a joining surface 631a formed at the outer circumference portion of the other surface (lower surface in FIG. 16) in the stacking direction of the first end plate. The joining surface 631a is in contact with the spacer 620 adjacent to each other at the other surface side in the stacking direction of the first end plate 631. In other words, the first end plate 631 includes the joining surface 631a facing the spacer 620 in the stacking direction of the cell members 650.

The second end plate 632 is disposed at the other end (lower end in FIG. 16) in the stacking direction of the plurality of cell members 550 and has a flat plate shape having a quadrangular planar shape. The second end plate 632 is made of a thermoplastic resin having sulfuric acid resistance. The second end plate 632 has a plate thickness greater than the plate thickness of a bipolar plate 610.

The second end plate 632 covers the negative electrode 652 of the cell member 650 at the other end side (lower end side in FIG. 16) in the stacking direction of the bipolar battery 600.

The second end plate 632 is disposed in parallel to the bipolar plate 610 and has a joining surface 632a formed at the outer circumference portion of one surface (upper surface in FIG. 16) in the stacking direction of the second end plate. The joining surface 632a is in contact with the spacer 620 adjacent to each other at one surface side in the stacking direction of the second end plate 632. In other words, the second end plate 632 includes the joining surface 632a facing the spacer 620 in the stacking direction of the cell members 650.

The spacers 620 are respectively disposed between the bipolar plates 610 adjacent to each other in the stacking direction, between the first end plate 631 and the bipolar plate 610, and between the second end plate 632 and the bipolar plate 610.

The spacer 620 disposed between the bipolar plates 610 adjacent to each other in the stacking direction is formed in a quadrangular frame shape to surround the side surface of the cell member 650. The spacer 620 is made of a thermoplastic resin having sulfuric acid resistance. The spacer 620 has a plate thickness greater than the plate thickness of the bipolar plate 610.

The spacer 620 is disposed in parallel to the bipolar plate 610 and has a joining surface 620a formed on one surface (upper surface in FIG. 16) in the stacking direction of the spacer. The joining surface 620a is in contact with the bipolar plate 610 adjacent to each other at one surface side in the stacking direction. The spacer 620 has a joining surface 620a also formed on the other surface (lower surface in FIG. 16) in the stacking direction of the spacer 620. The joining surface 620a is in contact with the bipolar plate 610 adjacent to each other at the other surface side in the stacking direction. In other words, the spacer 620 includes two joining surfaces 620a facing the two bipolar plates 610 in the stacking direction of the cell members 650.

The spacer 620 disposed between the first end plate 631 and the bipolar plate 610 is formed in a quadrangular frame shape to surround the side surface of the cell member 650. The spacer 620 is made of a thermoplastic resin having sulfuric acid resistance. The spacer 620 has a plate thickness greater than the plate thickness of the bipolar plate 610.

The spacer 620 is disposed in parallel with the bipolar plate 610 and has a joining surface 620a formed on one surface (upper surface in FIG. 16) in the stacking direction. The joining surface 620a is in contact with the first end plate 631 adjacent to each other at one surface side in the stacking direction. The spacer 620 has a joining surface 620a also formed on the other surface (lower surface in FIG. 16) in the stacking direction of the spacer. The joining surface 620a is in contact with the bipolar plate 610 adjacent to each other at the other surface side in the stacking direction. In other words, the spacer 620 includes two joining surfaces 620a facing the first end plate 631 and the bipolar plate 610 in the stacking direction (the vertical direction in FIG. 16) of the cell members 650.

Further, the spacer 620 disposed between the second end plate 632 and the bipolar plate 610 is formed in a quadrangular frame shape to surround the side surface of the cell member 650. The spacer 620 is made of a thermoplastic resin having sulfuric acid resistance. The spacer 620 has a plate thickness greater than the plate thickness of the bipolar plate 610.

The spacer 620 is disposed in parallel with the bipolar plate 610 and has a joining surface 620a formed on one surface (upper surface in FIG. 16) in the stacking direction. The joining surface 620a is in contact with the bipolar plate 610 adjacent to each other at one side in the stacking direction. The spacer 620 has a joining surface 620a also formed on the other surface (lower surface in FIG. 16) in the stacking direction. The joining surface 620a is in contact with the second end plate 632 adjacent to each other at the other side in the stacking direction. In other words, the spacer 620 includes two joining surfaces 620a facing the bipolar plate 610 and the second end plate 632 in the stacking direction (the vertical direction in FIG. 16) of the cell members 650.

A negative electrode lead layer 602 is disposed on one surface in the stacking direction of the bipolar plate 610. A positive electrode lead layer 601 is disposed on the other surface in the stacking direction of the bipolar plate 610. A negative active material layer 604 is disposed on the negative electrode lead layer 602 to form a negative electrode 652. A positive active material layer 603 is disposed on the positive electrode lead layer 601 to form a positive electrode 651.

Between the positive active material layer 603 and the negative active material layer 604 facing each other, an electrolyte layer 605 is disposed that is made of a glass fiber mat or the like impregnated with an electrolyte such as sulfuric acid.

A positive electrode lead layer 601 is disposed on the other surface in the stacking direction of the first end plate 631. A positive active material layer 603 is disposed on the positive electrode lead layer 601 on the first end plate 631 to form a positive electrode 651. Between the positive active material layer 603 on the first end plate 631 and the negative active material layer 604 of the bipolar plate 610 facing the positive active material layer, an electrolyte layer 605 is disposed that is made of a glass fiber mat or the like impregnated with an electrolyte such as sulfuric acid.

A negative electrode lead layer 602 is disposed on one surface in the stacking direction of the second end plate 632. A negative active material layer 604 is disposed on the negative electrode lead layer 602 on the second end plate 632 to form a negative electrode 652. Between the negative active material layer 604 on the second end plate 632 and the positive active material layer 603 of the bipolar plate 610 facing the negative active material layer, an electrolyte layer 605 is disposed that is made of a glass fiber mat or the like impregnated with an electrolyte such as sulfuric acid.

The positive electrode lead layer 601 on the first end plate 631 is provided with a positive electrode terminal 606 electrically conductive to the outside of the first end plate 631. The negative electrode lead layer 602 on the second end plate 632 is provided with a negative electrode terminal 607 electrically conductive to the outside of the second end plate 632.

In other words, the bipolar battery 600 according to the sixth embodiment includes the plurality of cell members 650 each including the positive electrode 651 having the positive active material layer 603, the negative electrode 652 having the negative active material layer 604, and the electrolyte layer 605 interposed between the positive electrode 651 and the negative electrode 652, and the plurality of frame units (the plurality of bipolar plates 610, the first end plate 631, the second end plate 632, and the plurality of spacers 620) forming the plurality of cells C (also called spaces) individually housing the plurality of cell members 650.

The plurality of frame units includes the plurality of bipolar plates 610 disposed between the cell members 650 adjacent to each other in the stacking direction, the first end plate 631 disposed at one end (upper end in FIG. 16) in the stacking direction of the plurality of cell members 650, the second end plate 632 disposed at the other end (lower end in FIG. 16) in the stacking direction of the plurality of cell members 650, and the plurality of spacers 620 disposed between the bipolar plates 610 adjacent to each other in the stacking direction, between the first end plate 631 and the bipolar plate 610, and between the second end plate 632 and the bipolar plate 610.

The plurality of cells C individually housing the plurality of cell members 650 is formed by the plurality of bipolar plates 610, the first end plate 631 and the second end plate 632, and the plurality of spacers 620.

The cell members 650 adjacent to each other in the stacking direction are electrically connected to each other in series. Therefore, the bipolar plate 610 interposed between the cell members 650 adjacent to each other in the stacking direction includes a means for electrically connecting the positive electrode lead layer 601 and the negative electrode lead layer 602.

Each of the plurality of frame units (the plurality of bipolar plates 610, the first end plate 631, the second end plate 632, and the plurality of spacers 620) has joining surfaces 631a and 620a, 620a and 610a, 610a and 620a, 620a and 610a, 610a and 620a, and 620a and 632a facing each other in the stacking direction of the cell members 650, which are joined to each other by a joining material 640.

Specifically, the joining surface 631a formed on the other surface in the stacking direction of the first end plate 631 and the joining surface 620a formed on one surface in the stacking direction of the spacer 620, which are adjacent to each other in the stacking direction, are joined to each other by the joining material 640. The joining surface 610a formed on one surface in the stacking direction of all the bipolar plates 610 and the joining surface 620a formed on the other surface in the stacking direction of all the spacers 620, which are adjacent to each other in the stacking direction, are also joined to each other by the joining material 640. The joining surface 610a formed on the other surface in the stacking direction of all the bipolar plates 610 and the joining surface 620a formed on one surface in the stacking direction of all the spacers 620, which are adjacent to each other in the stacking direction, are also joined to each other by the joining material 640. Further, the joining surface 632a formed on one surface in the stacking direction of the second end plate 632 and the joining surface 620a formed on the other surface in the stacking direction of the spacer 620, which are adjacent to each other in the stacking direction, are also joined to each other by the joining material 640.

As with the joining material 440 in the fourth embodiment and the joining material 540 in the fifth embodiment, the joining material 640 is an adhesive or a fusing material.

The fusing material is a fusing material generated by vibration welding. For example, when the joining surface 631a formed on the other surface in the stacking direction of the first end plate 631 and the joining surface 620a formed on one surface in the stacking direction of the spacer 620 are joined to each other, one joining surface 631a is pressed against the other joining surface 620a and vibrated to generate frictional heat. The one joining surface 631a and the other joining surface 620a are melted to generate melt, thereby forming a fusing material.

In the bipolar battery 600 according to the sixth embodiment configured as described above, the electrolyte layer 605 constituting the cell member 650 in the cell C is impregnated with an electrolyte.

On the other hand, as described above, each of the plurality of frame units (the plurality of bipolar plates 610, the first end plate 631, the second end plate 632, and the plurality of spacers 620) has the joining surfaces 631a and 620a, 620a and 610a, 610a and 620a, 620a and 610a, 610a and 620a, and 620a and 632a facing each other in the stacking direction of the cell members 650, which are joined to each other by the joining material 640.

Specifically, the joining surface 631a formed on the other surface in the stacking direction of the first end plate 631 and the joining surface 620a formed on one surface in the stacking direction of the spacer 620, which are adjacent to each other in the stacking direction, are joined to each other by the joining material 640. The joining surface 610a formed on one surface in the stacking direction of all the bipolar plates 610 and the joining surface 620a formed on the other surface in the stacking direction of all the spacers 620, which are adjacent to each other in the stacking direction, are also joined to each other by the joining material 640. The joining surface 610a formed on the other surface in the stacking direction of all the bipolar plates 610 and the joining surface 620a formed on one surface in the stacking direction of all the spacers 620, which are adjacent to each other in the stacking direction, are also joined to each other by the joining material 640. Further, the joining surface 632a formed on one surface in the stacking direction of the second end plate 632 and the joining surface 620a formed on the other surface in the stacking direction of the spacer 620, which are adjacent to each other in the stacking direction, are also joined to each other by the joining material 640.

Therefore, the electrolyte in the cell C can be prevented from leaking out from between the joining surfaces 631a and 620a, 620a and 610a, 610a and 620a, 620a and 610a, 610a and 620a, and 620a and 632a by the joining material 640.

However, depending on a joining mode of the joining material 640 between the joining surfaces 631a and 620a, 620a and 610a, 610a and 620a, 620a and 610a, 610a and 620a, and 620a and 632a, the electrolyte may leak out.

Therefore, also in the bipolar battery 600 according to the sixth embodiment, on the outer side surfaces 631b and 620b, and 620b and 632b of the frame units, which are adjacent to each other in the stacking direction, grooves 661 are formed which communicate between the joining surfaces 631a and 620a, and 620a and 632a, which are to be joined, and open to outer side surfaces 631b and 620b, and 620b and 632b. A water sealing material 662 is disposed in the grooves 661.

Specifically, also in the bipolar battery 600 according to the sixth embodiment, as in the bipolar battery 500 according to the fifth embodiment, on the outer side surface 631b of the first end plate 631 and the outer side surface 620b of the spacer 620, which are adjacent to each other in the stacking direction, a groove 661 is formed which communicates between the joining surface 631a formed on the other surface in the stacking direction of the first end plate 631 and the joining surface 620a formed on one surface in the stacking direction of the spacer 620, which are to be joined, and opens to the outer side surfaces 631b and 620b. The water sealing material 662 is disposed in the groove 661.

In the bipolar battery 600 according to the sixth embodiment, as in the bipolar battery 500 according to the fifth embodiment, on the outer side surface 632b of the second end plate 632 and the outer side surface 620b of the spacer 620, which are adjacent to each other in the stacking direction, a groove 661 is formed that communicates between the joining surface 632a formed on one surface in the stacking direction of the second end plate 632 and the joining surface 620a formed on the other surface in the stacking direction of the spacer 620, which are to be joined, and opens to the outer side surfaces 632b and 620b. The water sealing material 662 is disposed in the groove 661.

In the bipolar battery 600 according to the sixth embodiment, as in the bipolar battery 500 according to the fifth embodiment, for all (two in the present embodiment) the bipolar plates 610, on the outer side surface of the bipolar plate 610 and the outer side surface 620b of the spacer 620, which are adjacent to each other in the stacking direction, a groove similar to the groove 661 is formed that communicates between the joining surface 610a formed on one surface in the stacking direction of the bipolar plate 610 and the joining surface 620a formed on the other surface in the stacking direction of the spacer 620, which are to be joined.

In the bipolar battery 600 according to the sixth embodiment, for all the bipolar plates 610, on the outer side surface of the bipolar plate 610 and the outer side surface 620b of the spacer 620, which are adjacent to each other in the stacking direction, a groove similar to the groove 661 is formed that communicates between the joining surface 610a formed on the other surface in the stacking direction of the bipolar plate 610 and the joining surface 620a formed on one surface in the stacking direction of the spacer 620, which are to be joined.

In the bipolar battery 600 according to the sixth embodiment, as in the bipolar battery 500 according to the fifth embodiment, for all the bipolar plates 610, as illustrated in FIG. 16, the groove communicating between the joining surface 610a formed on one surface in the stacking direction of the bipolar plate 610 and the joining surface 620a formed on the other surface in the stacking direction of the spacer 620 and the groove communicating between the joining surface 610a formed on the other surface in the stacking direction of the bipolar plate 610 and the joining surface 620a formed on one surface in the stacking direction of the spacer 620 are an identical common groove 663 communicating with each other. A common water sealing material 664 is disposed in the common groove 663 instead of the water sealing material 662.

For the bipolar battery 600 according to the sixth embodiment, as in the bipolar battery 500 according to the fifth embodiment, even if the electrolyte leaking out of the cell C escapes the joining material 640 and leaks out from between the joining surfaces 631a and 620a, 620a and 610a, 610a and 620a, 620a and 610a, 610a and 620a, and 620a and 632a, the electrolyte can be reliably prevented from leaking out by the water sealing material 662 and the common water sealing material 664.

For the bipolar battery 600 according to the sixth embodiment, as in the bipolar battery 500 according to the fifth embodiment, a groove on one surface side in the stacking direction and a groove on the other surface side in the stacking direction of the bipolar plate 610 may be formed by one common groove 663, so that groove machining can be easily performed. One common water sealing material 664 may be disposed in the common groove 663, so that there is an advantage in that the number of components can be reduced compared to the bipolar battery 400 according to the fourth embodiment.

As in the bipolar battery 500 according to the fifth embodiment, because it is not necessary to form two grooves in each bipolar plate 610, the plate thickness of the bipolar plate 610 can be reduced, and there is an advantage in that the weight of the bipolar battery 600 can be reduced compared to the bipolar battery 400 according to the fourth embodiment.

The bipolar battery 600 according to the sixth embodiment is different from the bipolar battery 500 according to the fifth embodiment, and as illustrated in FIGS. 16 and 17, open ends 661a and 661b of each groove 661 are provided with protrusions 665 protruding from the open ends 661a and 661b.

Specifically, at the open end 661a on one side (upper side in FIG. 17) in the stacking direction (the vertical direction in FIG. 17) of each groove 661, a one-side protrusion 665a is formed that protrudes from the open end 661a on the one side toward the open end 661b on the other side (lower side in FIG. 17), and at the open end 661b on the other side, an other-side protrusion 665b is formed that protrudes from the open end 661b on the other side toward the open end 661a on the one side. The one-side protrusion 665a and the other-side protrusion 665b constitute the protrusion 665.

The bipolar battery 600 according to the sixth embodiment is different from the bipolar battery 500 according to the fifth embodiment, and as illustrated in FIGS. 16 and 17, the open ends 663a and 663b of each common groove 663 are also provided with protrusions 666 protruding from the open ends 663a and 663b.

Specifically, at the open end 663a on one side (upper side in FIG. 17) in the stacking direction (the vertical direction in FIG. 17) of each common groove 663, a one-side protrusion 666a is formed that protrudes from the open end 663a on the one side toward the open end 663b on the other side (lower side in FIG. 17), and at the open end 663b on the other side, an other-side protrusion 666b is formed that protrudes from the open end 663b on the other side toward the open end 663a on the one side. The one-side protrusion 666a and the other-side protrusion 666b constitute the protrusion 666.

For the bipolar battery 600 according to the sixth embodiment, because the open ends 661a and 661b of each groove 661 are provided with the protrusions 665 protruding from the open ends 661a and 661b, the water sealing material 662 disposed in each groove 661 can be retained and positioned, and the water sealing material 662 can be suppressed from leaking out when the liquid water sealing material 662 is poured into the groove 661 before being solidified. The protrusion 665 can increase the creepage distance in the groove 661 in contact with the water sealing material 662 and improve the effect of preventing the electrolyte from leaking out.

For the bipolar battery 600 according to the sixth embodiment, because the open ends 663a and 663b of each common groove 663 are provided with the protrusions 666 protruding from the open ends 663a and 663b, the common water sealing material 664 disposed in each common groove 663 can be retained and positioned, and the common water sealing material 664 can be suppressed from leaking out when the liquid common water sealing material 664 is poured into the common groove 663 before being solidified. The protrusion 666 can increase the creepage distance in the common groove 663 in contact with the common water sealing material 664 and improve the effect of preventing the electrolyte from leaking out.

The shape of each groove 661 and the shape of each common groove 663 will now be described with reference to FIG. 17. The shape of each water sealing material 662 and the shape of each common water sealing material 664 will now be described with reference to FIGS. 17, 18A, and 18B. FIG. 17 illustrates an enlarged state of a portion indicated by an arrow Z in FIG. 16. FIG. 18A is a cross-sectional view of the water sealing material used in the bipolar battery illustrated in FIG. 16 and FIG. 18B is a cross-sectional view of the common water sealing material used in the bipolar battery illustrated in FIG. 16.

Because the shapes of the groove 661 communicating the joining surfaces 631a and 620a to be joined and the groove 661 communicating the joining surfaces 620a and 632a to be joined, and the shape of the water sealing material 662 disposed in each of these grooves 661 are identical, only the shape of the groove 661 communicating the joining surfaces 631a and 620a to be joined and the shape of the water sealing material 662 disposed in the groove 661 will be described. The description of the shapes of the other grooves 661 and the water sealing material 662 disposed in the groove 661 will be omitted.

The cross-sectional shape of the groove 661 communicating the joining surfaces 631a and 620a to be joined has a shape obtained by subtracting the one-side protrusion 665a and the other-side protrusion 665b from a rectangular shape having a height W4 in the stacking direction (the vertical direction in FIG. 17) and a depth D3 in the direction orthogonal to the stacking direction (the horizontal direction in FIG. 17). The groove 661 opens to the outer side surface 631b of the first end plate 631 and the outer side surface 620b of the spacer 620. The groove 661 is continuously formed in an endless shape over the entire circumference of the quadrangular shaped first end plate 631 and the quadrangular frame-shaped spacer 620.

The one-side protrusion 665a of the protrusion 665 has a thickness ta1 and protrudes by a protruding length ha1 from the open end 661a on one side (upper side in FIG. 17) in the stacking direction of the groove 661 toward the open end 661b on the other side (lower side in FIG. 17).

The other-side protrusion 665b of the protrusion 665 has a thickness tb1 and protrudes by a protruding length hb1 from the open end 661b on the other side in the stacking direction of the groove 661 toward the open end 661a on the one side.

The one-side protrusion 665a and the other-side protrusion 665b constituting the protrusion 665 are continuously formed in an endless shape over the entire circumference of the quadrangular shaped first end plate 631 and the quadrangular frame-shaped spacer 620 in accordance with the groove 661.

As illustrated in FIGS. 17 and 18A, the water sealing material 662 disposed in the groove 661 that communicates the joining surfaces 631a and 620a to be joined has a quadrangular frame shape having a shape complementary to that of the groove 661 provided with the protrusion 665. The cross-sectional shape of the water sealing material 662 includes a rectangular first portion 662a and a rectangular second portion 662b that is in contact with the first portion 662a and is smaller than the first portion 662a.

A height H4 in the stacking direction of the first portion 662a of the water sealing material 662 has the same dimension as the height W4 in the stacking direction of the groove 661, and a thickness t5 in the direction orthogonal to the stacking direction of the combination of the first portion 662a and the second portion 662b of the water sealing material 662 has the same dimension as the depth D3 of the groove 661. The height in the stacking direction of the second portion 662b of the water sealing material 662 has a dimension obtained by subtracting, from the height H4 in the stacking direction of the first portion 662a, a height W5 equal to the protruding length ha1 of the one-side protrusion 665a provided in the groove 661 and a height W6 equal to the protruding length hb1 of the other-side protrusion 665b. The second portion 662b of the water sealing material 662 has a thickness t4 in the direction orthogonal to the stacking direction.

In the first end plate 631 on one side (upper side in FIG. 17), the creepage distance in the groove 661 in contact with the water sealing material 662 (the distance from when the electrolyte passes between the joining surfaces 631a and 620a to when the electrolyte passes through to the outside) is the sum of a stacking direction distance Wa4 in the groove 661 in contact with the water sealing material 662, the distance in the direction orthogonal to the stacking direction in the groove 661 in contact with the water sealing material 662 (the distance equal to the thickness t5 of the water sealing material 662), and the protruding length ha1 of the one-side protrusion 665a.

In the spacer 620 on the other side (lower side in FIG. 17), the creepage distance in the groove 661 in contact with the water sealing material 662 (the distance from when the electrolyte passes between the joining surfaces 631a and 620a to when the electrolyte passes through to the outside) is the sum of a stacking direction distance Wb4 in the groove 661 in contact with the water sealing material 662, the distance in the direction orthogonal to the stacking direction in the groove 661 in contact with the water sealing material 662 (the distance equal to the thickness t5 of the water sealing material 662), and the protruding length hb1 of the other-side protrusion 665b.

The longer the creepage distance in the groove 661 is in contact with the water sealing material 662, the greater the water sealing effect (the effect of suppressing the electrolyte from leaking out) by the water sealing material 662.

To increase the creepage distance, it is necessary to increase the stacking direction distances Wa4 and Wb4, the thickness t5 of the water sealing material 662, or the protruding lengths ha1 and hb1. But, if the thickness t5 of the water sealing material 662 is increased, it is necessary to increase the depth D3 of the groove 661. If the depth D3 of the groove 661 is increased, the joining width B3 of the joining material 640 at the joining surfaces 631a and 620a is reduced, and thus the water sealing effect of the joining material 640 is reduced. On the other hand, if the joining width B3 of the joining material 640 at the joining surfaces 631a and 620a is maintained in a state in which the depth D3 of the groove 661 is increased, a width T3 of the spacer is increased, and there is a problem in that the bipolar battery 600 is increased in size.

Therefore, to increase the creepage distance, it is preferable to increase the stacking direction distances Wa4 and Wb4. To increase the stacking direction distances Wa4 and Wb4, it is preferable that the height H4 in the stacking direction of the water sealing material 662 is increased larger than the thickness t5 in the direction orthogonal to the stacking direction of the water sealing material 662.

By increasing the height H4 in the stacking direction of the water sealing material 662 larger than the thickness t5 in the direction orthogonal to the stacking direction of the water sealing material 662 (H4>t5), it is possible to increase the creepage distance in the groove 661 in contact with the water sealing material 662 while maintaining the joining width B3 of the joining material 640 and the width T3 of the spacer 620 at the joining surfaces 631a and 620a, thereby improving the water sealing effect. The same applies to the water sealing material 662 disposed in the groove 661 communicating the joining surfaces 632a and 620a.

The shape of the common groove 663 will now be described. As illustrated in FIG. 17, the cross-sectional shape of the identical common groove 663 in which a groove communicating the joining surface 610a formed on one surface in the stacking direction of the bipolar plate 610 and the joining surface 620a formed on the other surface in the stacking direction of the spacer 620 and a groove communicating the joining surface 610a formed on the other surface in the stacking direction of the bipolar plate 610 and the joining surface 620a formed on one surface in the stacking direction of the spacer 620 communicate with each other. The common groove 663 has a shape obtained by subtracting the one-side protrusion 666a and the other-side protrusion 666b from a rectangular shape having a height W5 in the stacking direction (the vertical direction in FIG. 17) and the depth D3 in the direction (the horizontal direction in FIG. 17) orthogonal to the stacking direction. The common groove 663 opens over the outer side surface 620b of the spacer 620 on one surface side in the stacking direction of the bipolar plate 610, the outer side surface of the bipolar plate 610, and the outer side surface 620b of the spacer 620 on the other surface side in the stacking direction of the bipolar plate 610. The common groove 663 is continuously formed in an endless shape over the entire circumference of the two quadrangular frame-shaped spacers 620 and the quadrangular shaped bipolar plate 610.

The one-side protrusion 666a of the protrusion 666 has a thickness ta2 and protrudes by a protruding length ha2 from the open end 663a on one side (upper side in FIG. 17) in the stacking direction of the common groove 663 toward the open end 663b on the other side (lower side in FIG. 17).

The other-side protrusion 666b of the protrusion 666 has a thickness tb2 and protrudes by a protruding length hb2 from the open end 663b on the other side in the stacking direction of the common groove 663 toward the open end 663a on the one side.

The one-side protrusion 666a and the other-side protrusion 666b constituting the protrusion 666 are continuously formed in an endless shape over the entire circumference of the two quadrangular frame-shaped spacers 620 and the quadrangular shaped bipolar plate 610 in accordance with the common groove 663.

As illustrated in FIGS. 17 and 18B, the common water sealing material 664 disposed in the common groove 663 has a quadrangular frame shape having a shape complementary to that of the common groove 663. The cross-sectional shape of the common water sealing material 664 includes a rectangular first portion 664a and a rectangular second portion 664b that is in contact with the first portion 664a and is smaller than the first portion 664a.

A height H7 in the stacking direction of the first portion 664a of the common water sealing material 664 has the same dimension as the height W5 in the stacking direction of the common groove 663, and a thickness t7 in the direction orthogonal to the stacking direction of the combination of the first portion 664a and the second portion 664b of the common water sealing material 664 has the same dimension as the depth D3 of the common groove 663. The height in the stacking direction of the second portion 664b of the common water sealing material 664 has a dimension obtained by subtracting, from the height H7 in the stacking direction of the first portion 664a, a height H8 equal to the protruding length ha2 of the one-side protrusion 666a provided in the common groove 663, and a height H9 equal to the protruding length hb2 of the other-side protrusion 666b. The second portion 664b of the common water sealing material 664 has a thickness t6 in the direction orthogonal to the stacking direction.

In the spacer 620 on one side (upper side in FIG. 17), the creepage distance in the common groove 663 in contact with the common water sealing material 664 (the distance from when the electrolyte passes between the joining surfaces 610a and 620a to when the electrolyte passes through to the outside) is the sum of a stacking direction distance Wa5 in the common groove 663 in contact with the common water sealing material 664, the distance in the direction orthogonal to the stacking direction in the common groove 663 in contact with the common water sealing material 664 (the distance equal to the thickness t7 of the common water sealing material 664), and the protruding length ha2 of the one-side protrusion 666a.

In the spacer 620 on the other side (lower side in FIG. 17), the creepage distance in the common groove 663 in contact with the common water sealing material 664 (the distance from when the electrolyte passes between the joining surfaces 610a and 620a to when the electrolyte passes through to the outside) is the sum of a stacking direction distance Wb5 in the common groove 663 in contact with the common water sealing material 664, the distance in the direction orthogonal to the stacking direction in the common groove 663 in contact with the common water sealing material 664 (the distance equal to the thickness t7 of the common water sealing material 664), and the protruding length hb2 of the other-side protrusion 666b.

The longer the creepage distance in the common groove 663 is in contact with the common water sealing material 664, the greater the water sealing effect (the effect of suppressing the electrolyte from leaking out) by the common water sealing material 664.

To increase the creepage distance, it is necessary to increase the stacking direction distances Wa5 and Wb5, the thickness t7 of the common water sealing material 664, or the protruding lengths ha2 and, hb2. But, if the thickness t7 of the common water sealing material 664 is increased, it is necessary to increase the depth D3 of the common groove 663. If the depth D3 of the common groove 663 is increased, the joining width B3 of the joining material 640 at the joining surfaces 610a and 620a is reduced, and thus the water sealing effect of the joining material 640 is reduced. On the other hand, if the joining width B3 of the joining material 640 at the joining surfaces 610a and 620a is maintained in a state in which the depth D3 of the common groove 663 is increased, the width T3 of the spacer is increased, and there is a problem in that the bipolar battery 600 is increased in size.

Therefore, to increase the creepage distance, it is preferable to increase the stacking direction distances Wa5 and Wb5. To increase the stacking direction distances Wa5 and Wb5, it is preferable that the height H7 in the stacking direction of the common water sealing material 664 is increased larger than the thickness t7 in the direction orthogonal to the stacking direction of the common water sealing material 664.

By increasing the height H7 in the stacking direction of the common water sealing material 664 larger than the thickness t7 in the direction orthogonal to the stacking direction of the common water sealing material 664 (H7>t7), it is possible to increase the creepage distance in the common groove 663 in contact with the common water sealing material 664 while maintaining the joining width B3 of the joining material 640 at the joining surfaces 610a and 620a and the width T3 of the spacer 620, thereby improving the water sealing effect. The same applies to the common water sealing material 664 disposed between the other joining surfaces 610a and 620a.

As with the water sealing material 562 according to the fifth embodiment, the material of the water sealing material 662 is preferably any of dope cement, hot melt, or a liquid gasket, or any combination thereof. Thus, according to the bipolar battery 600 according to the sixth embodiment, because the water sealing material 662 is any of the dope cement, the hot melt, and the liquid gasket, the water sealing material 662 can be disposed in the groove 661 by a simple work process. The electrolyte can be reliably prevented from leaking out of the cell C.

The material of the common water sealing material 664 is the same as that of the water sealing material 662, and is preferably any of dope cement, hot melt, and a liquid gasket. Thus, for the bipolar battery 600 according to the sixth embodiment, because the common water sealing material 664 is any of the dope cement, the hot melt, and the liquid gasket, the common water sealing material 664 can be disposed in the common groove 663 by a simple work process. The electrolyte can be reliably prevented from leaking out of the cell C.

Although the embodiments of the present invention have been described above, the present invention is not limited to the embodiments, and various changes and improvements can be made.

For example, the joining method at the joining surfaces 112a, 122a, and 132a in the bipolar battery 100 according to the first embodiment is not limited to joining by an adhesive or vibration welding and may be joining by other welding processes such as thermal welding by a hot plate or infrared heating, or solvent melting. The same applies to the joining method at the joining surface in the bipolar lead storage battery 200 according to the second embodiment and the joining method at the joining surface in the bipolar battery 300 according to the third embodiment.

The electrical connection means provided on the substrates 111, 211, and 311 in the respective bipolar storage batteries 100, 200, and 300 according to the first to third embodiments is not limited to a specific method. For example, it is also possible to electrically connect both surfaces of the substrates by including conductive particles or conductive fibers in the entire substrates. It is also possible to incorporate a conductive member capable of electrical conduction in the substrates.

In the bipolar battery 200 according to the second embodiment, the groove 261 communicating between the joining surfaces 212a and 212a is formed on both the outer side surface 212b of the rim 212 on one side (upper side in FIG. 4) in the stacking direction (the vertical direction in FIG. 4) and the outer side surface 212b of the rim 212 on the other side (lower side in FIG. 4) in the stacking direction, but may be formed only on the outer side surface 212b of the rim 212 on one side (upper side in FIG. 4) in the stacking direction. In the bipolar battery 200 according to the second embodiment, the groove 261 communicating between the joining surfaces 212a and 222a may also be formed only on the outer side surface 212b of the rim 212 on one side (upper side in FIG. 4) in the stacking direction. In the bipolar battery 200 according to the second embodiment, the groove 261 communicating between the joining surfaces 232a and 212a may also be formed only on the outer side surface 232b of the rim 232 on one side (upper side in FIG. 4) in the stacking direction.

In the bipolar battery 300 according to the third embodiment, the water sealing material 362 includes the first portion 362a and the second portion 362b each having a rectangular shape but may be formed only by the first portion 362a.

The joining method at the joining surfaces 431a and 420a, 420a and 410a, 410a and 420a, 420a and 410a, 410a and 420a, and 420a and 432a in the bipolar battery 400 according to the fourth embodiment is not limited to joining by an adhesive or vibration welding and may be joining by other welding processing such as thermal welding by a hot plate or infrared heating, or solvent melting. The same applies to the joining method at the joining surfaces in the bipolar battery 500 according to the fifth embodiment and the joining method at the joining surfaces in the bipolar battery 600 according to the sixth embodiment.

The electrical connection means provided on the bipolar plates 410, 510, and 610 in the respective bipolar storage batteries 400, 500, and 600 according to the fourth to sixth embodiments is not limited to a specific method. For example, it is also possible to electrically connect both surfaces of the substrates by including conductive particles or conductive fibers in the entire substrates. It is also possible to incorporate a conductive member capable of electrical conduction in the substrates.

In the bipolar battery 600 according to the sixth embodiment, the protrusion 665 is provided in the groove 661, and the protrusion 666 is provided in the common groove 663, but the protrusion 665 may be provided only in the groove 661, and the protrusion 666 may not be provided in the common groove 663. On the other hand, the protrusion 665 may not be provided in the groove 661, and the protrusion 666 may be provided only in the common groove 663.

In the bipolar battery 400 according to the fourth embodiment, a protrusion may be provided in the groove 161.

In the bipolar battery 600 according to the sixth embodiment, the water sealing material 662 includes the first portion 662a and the second portion 662b each having a rectangular shape, but the water sealing material 662 may be formed only by the first portion 662a. The common water sealing material 664 may also be formed only by the first portion 664a.

The bipolar battery 100 according to the first embodiment is a bipolar lead storage battery in which the positive electrode 151 has the positive electrode lead layer 101 and the negative electrode 152 has the negative electrode lead layer 102 but may be a bipolar battery in which a metal other than lead is used for the positive electrode 151 and the negative electrode 152. The same applies to the bipolar battery 200 according to the second embodiment, the bipolar battery 300 according to the third embodiment, the bipolar battery 400 according to the fourth embodiment, the bipolar battery 500 according to the fifth embodiment, and the bipolar battery 600 according to the sixth embodiment.

### INDUSTRIAL APPLICABILITY

In the bipolar battery according to embodiments of the present invention, the electrolyte can be reliably prevented from leaking out of the cell C by a simple seal configuration, so that both high energy density and long-term reliability can be achieved, and the bipolar battery can be very advantageously used in various industries.

The following is a list of reference signs used in this specification and in the drawings.
100, 200, 300 BIPOLAR BATTERY
101, 201, 301 POSITIVE ELECTRODE LEAD LAYER
102, 202, 302 NEGATIVE ELECTRODE LEAD LAYER
103, 203, 303 POSITIVE ACTIVE MATERIAL LAYER
104, 204, 304 NEGATIVE ACTIVE MATERIAL LAYER
105, 205, 305 ELECTROLYTE LAYER
106, 206, 306 POSITIVE ELECTRODE TERMINAL
107, 207, 307 NEGATIVE ELECTRODE TERMINAL
110, 210, 310 INTERNAL FRAME UNIT
111, 211, 311 SUBSTRATE (BIPOLAR PLATE)
112, 212, 312 RIM
112a, 212a, 312a JOINING SURFACE
112b, 212b, 312b OUTER SIDE SURFACE
120, 220, 320 FIRST END FRAME UNIT
121, 221, 321 FIRST END PLATE
122, 222, 322 RIM
122a, 222a, 322a JOINING SURFACE
130, 230, 330 SECOND END FRAME UNIT
131, 231, 331 SECOND END PLATE
132, 232, 332 RIM
132a, 232a, 332a JOINING SURFACE
140, 240, 340 JOINING MATERIAL
150, 250, 350 CELL MEMBER
151, 251, 351 POSITIVE ELECTRODE
152, 252, 352 NEGATIVE ELECTRODE
161, 261, 361 GROOVE
162, 262, 362 WATER SEALING MATERIAL
361a OPEN END ON ONE SIDE
361b OPEN END ON OTHER SIDE
362a FIRST PORTION
362b SECOND PORTION
363 PROTRUSION
363a ONE-SIDE PROTRUSION
363b OTHER-SIDE PROTRUSION
400, 500, 600 BIPOLAR BATTERY
401, 501, 601 POSITIVE ELECTRODE LEAD LAYER
402, 502, 602 NEGATIVE ELECTRODE LEAD LAYER
403, 503, 603 POSITIVE ACTIVE MATERIAL LAYER
404, 504, 604 NEGATIVE ACTIVE MATERIAL LAYER
405, 505, 605 ELECTROLYTE LAYER
406, 506, 606 POSITIVE ELECTRODE TERMINAL
407, 507, 607 NEGATIVE ELECTRODE TERMINAL
410, 510, 610 BIPOLAR PLATE
410a, 510a, 610a JOINING SURFACE
410b, 510b OUTER SIDE SURFACE
420, 520, 620 SPACER
420a, 520a, 620a JOINING SURFACE
420b, 520b, 620b OUTER SIDE SURFACE
431, 531, 631 FIRST END PLATE
431a, 531a, 631a JOINING SURFACE
431b, 531b, 631b OUTER SIDE SURFACE
432, 532, 632 SECOND END PLATE
432a, 532a, 632a JOINING SURFACE
432b, 532b, 632b OUTER SIDE SURFACE
450, 550, 650 CELL MEMBER
451, 551, 651 POSITIVE ELECTRODE
452, 552, 652 NEGATIVE ELECTRODE
461, 561, 661 GROOVE
462, 562, 662 WATER SEALING MATERIAL
463, 563 COMMON GROOVE
564, 664 COMMON WATER SEALING MATERIAL
661a, 663a OPEN END ON ONE SIDE
661b, 663b OPEN END ON OTHER SIDE
662a, 664a FIRST PORTION
662b, 664b SECOND PORTION
665, 666 PROTRUSION
665a, 666a ONE-SIDE PROTRUSION
665b, 666b OTHER-SIDE PROTRUSION
C CELL (SPACE FOR HOUSING CELL MEMBER)

What is claimed is:

1. A bipolar battery, comprising:
a plurality of cell members each including a positive electrode having a positive active material layer, a negative electrode having a negative active material layer, and an electrolyte layer interposed between the positive electrode and the negative electrode; and
a plurality of frame units configured to form a plurality of cells individually housing the plurality of cell members, wherein:
cell members adjacent to each other in a stacking direction are electrically connected to each other in series;
each of the plurality of frame units has joining surfaces facing each other in a stacking direction of the cell members, the joining surfaces being joined to each other by a joining material;
a groove is formed on outer side surfaces of frame units adjacent to each other in the stacking direction, the groove communicating between the joining surfaces to be joined and opening to the outer side surfaces; and
a water sealing material is disposed in the groove.

2. The bipolar battery according to claim 1, wherein the bipolar battery is a bipolar lead storage battery in which the positive electrode has a positive electrode lead layer and the negative electrode has a negative electrode lead layer.

3. The bipolar battery according to claim 1, wherein:
each of the plurality of frame units includes a rim having the joining surfaces facing each other in a stacking direction of the cell members;
the joining surfaces of rims of frame units adjacent to each other in the stacking direction are joined to each other by the joining material;
the groove is formed on outer side surfaces of rims of frame units adjacent to each other in the stacking direction; and
the water sealing material is disposed in the groove.

4. The bipolar battery according to claim 3, wherein the water sealing material is dope cement.

5. The bipolar battery according to claim 3, wherein the water sealing material is hot melt.

6. The bipolar battery according to claim 3, wherein the water sealing material is a liquid gasket.

7. The bipolar battery according to claim 3, wherein an open end of the groove has a protrusion protruding from the open end.

8. The bipolar battery according to claim 3, wherein the bipolar battery is a bipolar lead storage battery in which the positive electrode has a positive electrode lead layer and the negative electrode has a negative electrode lead layer.

9. The bipolar battery according to claim 1, wherein:
each of the plurality of frame units includes one or a plurality of bipolar plates disposed between the cell members adjacent to each other in the stacking direction, a first end plate disposed at one end in the stacking direction of a plurality of the cell members and a second end plate disposed at an other end in the stacking direction, and a plurality of spacers disposed between the bipolar plates adjacent to each other in the stacking direction, between the first end plate and the bipolar plate, and between the second end plate and the bipolar plate;
a plurality of cells individually housing the plurality of cell members is formed by the one or plurality of bipolar plates, the first end plate and the second end plate, and the plurality of spacers;
the joining surface formed on an other surface in the stacking direction of the first end plate and the joining surface formed on one surface in the stacking direction of the spacer are adjacent to each other in the stacking direction and joined to each other by the joining material;
the joining surface formed on one surface in the stacking direction of the bipolar plate and the joining surface formed on an other surface in the stacking direction of the spacer are adjacent to each other in the stacking direction and joined to each other by the joining material;
the joining surface formed on an other surface in the stacking direction of the bipolar plate and the joining surface formed on one surface in the stacking direction of the spacer are adjacent to each other in the stacking direction and joined to each other by the joining material;
the joining surface formed on one surface in the stacking direction of the second end plate and the joining surface formed on an other surface in the stacking direction of the spacer are adjacent to each other in the stacking direction and joined to each other by the joining material; and
the groove is formed on an outer side surface of the first end plate and an outer side surface of the spacer adjacent to each other in the stacking direction, an outer side surface of the spacer and an outer side surface of the bipolar plate adjacent to each other in the stacking direction, and an outer side surface of the second end plate and an outer side surface of the spacer adjacent to each other in the stacking direction, and the water sealing material is disposed in the groove.

10. The bipolar battery according to claim 9, wherein an open end of the groove has a protrusion protruding from the open end.

11. The bipolar battery according to claim 9, wherein the water sealing material is dope cement.

12. The bipolar battery according to claim 9, wherein the water sealing material is hot melt.

13. The bipolar battery according to claim 9, wherein the water sealing material is a liquid gasket.

14. The bipolar battery according to claim 9, wherein the bipolar battery is a bipolar lead storage battery in which the positive electrode has a positive electrode lead layer and the negative electrode has a negative electrode lead layer.

15. The bipolar battery according to claim 9, wherein the groove communicating between the joining surface formed on one surface in the stacking direction of the bipolar plate and the joining surface formed on the other surface in the stacking direction of the spacer, and the groove communicating between the joining surface formed on the other surface in the stacking direction of the bipolar plate and the joining surface formed on one surface in the stacking direction of the spacer are an identical common groove communicating with each other, and the water sealing material disposed in the common groove is a common water sealing material.

16. The bipolar battery according to claim 15, wherein an open end of the common groove has a protrusion protruding from the open end.

17. The bipolar battery according to claim 15, wherein the common water sealing material is dope cement.

18. The bipolar battery according to claim 15, wherein the common water sealing material is hot melt.

19. The bipolar battery according to claim 15, wherein the common water sealing material is a liquid gasket.

20. The bipolar battery according to claim 15, wherein an open end of the groove has a protrusion protruding from the open end.
